(19) United States
(12) Patent Application Publication
(10) Pub. No.: US 2025/0298873 A1
(43) Pub. Date: Sep. 25, 2025

(54) IDENTIFICATION AUTHENTICATION AND DATA QUALIFICATION

(71) Applicant: FlexPath DXP, LLC, Cincinnati, OH (US)

(72) Inventors: Tarry E. SHEBESTA, Cincinnati, OH (US); Joseph IBERSHOFF, Crestwood, KY (US)

(21) Appl. No.: 19/088,096

(22) Filed: Mar. 24, 2025

Related U.S. Application Data
(60) Provisional application No. 63/569,517, filed on Mar. 25, 2024.

(51) Int. Cl. G06F 21/31

(52) U.S. Cl. CPC G06F 21/31

(57) ABSTRACT

Methods, systems, and computer program products for implementing an identification authentication process. A method may include receiving confirmation of an identification (ID) verification for a verified character string associated with a user, the verified character string including a plurality of numbers associated with a phone number of a user device. The method may further include determining, based on the phone number, a verification of ID data associated with the user by obtaining the ID data from a data provider entity. The method may further include obtaining credit profile data associated with the user from a credit profile entity based on the ID data. The method may further include providing, based on obtaining the credit profile data, an ID credit check confirmation associated with the ID data and phone number associated with the user.

### CROSS-REFERENCE TO RELATED APPLICATIONS

This application claims priority to U.S. Provisional Application No. 63/569,517, filed Mar. 25, 2024, which is hereby incorporated by reference herein in its entirety.

### TECHNICAL FIELD

The present invention generally relates to computers and computer software, and more specifically, to methods, systems, and computer program products for implementing procedures associated with an identification authentication and data qualification system.

### BACKGROUND

Many consumers finance significant purchases, arranging credit to spread payments out over a period. For example, the majority of home, car or boat purchasers arrange financing to pay for such purchases. There is a significant market in providing credit or loans to such consumers. Facilitating marketing of such is advantageous to those parties who are willing to make such loans, as well as to consumers desiring to obtain credit for purchases.

In recent years, digital retailing solutions have been offered to stakeholders/vendors (e.g., auto dealers) to help create a seamless online buying experience. However, one issue with these digital retailing solutions was an integrated credit prequalification that occurred further down the buying funnel compared to up front where consumer expectations could be better served. Additionally, fraudulent activities related to loan qualifications are constantly worrisome in the FinTech industry. Therefore, improved solutions for mitigating fraud while making it easier and faster for consumers to get prequalified are needed.

### SUMMARY

In embodiments of the invention, a method for implementing an identification authentication process for a data qualification system is provided. The method, at an electronic device including one or more processors, includes receiving confirmation of an identification (ID) verification for an already-verified character string associated with a user, the verified character string including a plurality of numbers associated with a phone number of a user device. The method further includes determining, based on the phone number, a verification of ID data associated with the user by obtaining the ID data from a data provider entity. The method further includes obtaining credit profile data associated with the user from a credit profile entity based on the ID data. The method further includes providing, based on obtaining the credit profile data, an ID credit check confirmation associated with the ID data and phone number associated with the user.

These and other embodiments can each optionally include one or more of the following features.

In some embodiments of the invention, the ID verification for the verified character string associated with the user is determined by receiving an ID verification request from a user device associated with the user via an application window of an ID verification user interface, receiving input of a first character string at an input field via the application window of the ID verification user interface, the first character string including the plurality of numbers associated with the phone number of the user device, providing a one-time passcode to the user device based on the first character string, receiving input of a second character string at an input field via the application window of the ID verification user interface, the second character string including one or more characters, and determining the verified character string based on matching the second character string to the one-time passcode.

In some embodiments of the invention, determining the verification of ID data associated with the user is verified includes receiving a first selection that confirms the displayed portion of the ID data associated with the user is verified via an application window of an ID verification user interface.

In some embodiments of the invention, determining the verification of ID data associated with the user is verified includes receiving a second selection that confirms the displayed portion of the ID data associated with the user is not verified via the application window of an ID verification user interface, displaying one or more additional user verification input fields via the application window of the ID verification user interface, receiving input of a third character string at the one or more additional user verification input fields via the application window of the ID verification user interface, the second character string including a plurality of characters or numbers associated with an address, and determining that the input of a third character string at the one or more additional user verification input fields confirms that the user is verified.

In some embodiments of the invention, determining that the input of the third character string at the one or more additional user verification input fields confirms that the user is verified includes receiving a third selection that confirms a display of the input of the second character string at the one or more additional user verification input fields is verified via the application window of the ID verification user interface.

In some embodiments of the invention, the method further includes the actions of determining, via a fraud detection module, whether the verification of the ID data associated with the user is likely to be fraudulent based on historical data and real-time data associated with the user.

In some embodiments of the invention, the credit profile data is obtained via a credit report application program interface (API) platform.

In some embodiments of the invention, the method further includes the actions of determining, via a fraud detection module, whether the obtained credit data associated with the user from the credit profile entity is likely to be fraudulent based on historical data and real-time data associated with the user.

In some embodiments of the invention, the method further includes the actions of determining a prequalification status for the user based on the obtained credit profile data. In some embodiments of the invention, determining the prequalification status for the user includes a credit prequalification determination using a prequalification engine and based on at least one a shop-by-payment service, a get prequalified service, or a single-product prequalification service.

In some embodiments of the invention, the prequalification engine is configured to ingest a plurality of user-based credit rates, a plurality of credit rules from a plurality of credit providers, and guidelines to determine credit qualifications for a plurality of users. In some embodiments of the invention, the prequalification engine determines credit qualifications for the plurality of users using a machine learning algorithm that is trained to predict ratings using historical rate sheets from one or more of the plurality of credit providers. In some embodiments of the invention, the prequalification engine determines credit qualifications for the plurality of users using a machine learning algorithm that is trained to predict rates using historical data of rates granted to other users by one or more of the plurality of credit providers along with historical credit profile data for those users.

In some embodiments of the invention, the method further includes the actions of determining the net valuation for an item owned by the user based on the obtained credit profile data.

In some embodiments of the invention, determining the net valuation for an item owned by the user includes a credit-enhanced valuation using a trade-in equity engine and based on a credit-enhanced trade-in equity valuation service.

In some embodiments of the invention, obtaining the ID data associated with a user from the data provider entity is based on a reverse phone lookup application program interface (API) service.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates an example environment for implementing an identification authentication process and a data qualification process, according to embodiments of the invention.

FIG. 2 illustrates an example of an identification authentication process based on an identification verification request, according to embodiments of the invention.

FIG. 3 illustrates an example of a data qualification process based on receiving verification data, according to embodiments of the invention.

FIGS. 4A-4D illustrate example screenshots for an identification authentication process via a user interface, according to embodiments of the invention.

FIG. 5A illustrates an example of an identification authentication process, according to embodiments of the invention.

FIG. 5B illustrates an example of an identification authentication process, according to embodiments of the invention.

FIG. 6 illustrates an example of a credit profile lookup process, according to embodiments of the invention.

FIG. 7 illustrates an example of a prequalification process based on an identification authentication from FIG. 6, according to embodiments of the invention.

FIG. 8 illustrates an example of a prequalification process based on an identification authentication from FIG. 6, according to embodiments of the invention.

FIG. 9 illustrates an example of a prequalification process based on an identification authentication from FIG. 6, according to embodiments of the invention.

FIG. 10 illustrates an example of a valuation process based on an identification authentication from FIG. 6, according to embodiments of the invention.

FIG. 11 is a flowchart of an example process for implementing an identification authentication process, according to embodiments of the invention.

FIG. 12 is a flowchart of an example process for implementing an identification authentication process, according to embodiments of the invention.

FIG. 13 is a block diagram showing an example computer architecture for a computer capable of executing the software components described herein, according to embodiments described herein.

### DETAILED DESCRIPTION

This application is related to the following U.S. Patent Applications, U.S. patent application Ser. No. 16/102,508, entitled SYSTEMS AND METHODS FOR DISPLAYING VEHICLES TO AN ONLINE SHOPPER IN SHOP-BY-PAYMENT FORMAT BASED ON ACTUAL MONTHLY PAYMENT AMOUNT, which is a Divisional of U.S. patent application Ser. No. 13/644,931, entitled SYSTEMS AND METHODS FOR IDENTIFYING ITEMS OF COLLATERAL AVAILABLE TO A CONSUMER PURSUANT TO PRE-QUALIFIED FINANCE TERMS THAT ARE CONSISTENT WITH CONSUMER SPECIFIED PAYMENT CRITERIA, which is a Continuation in-part of U.S. patent application Ser. No. 13/090,179, entitled SYSTEMS AND METHODS FOR DETERMINING PRE-QUALIFIED FINANCE OFFERS, the contents of each of which are herein incorporated by reference in its entirety.

The technology in this patent application is related to systems and methods for implementing integration of identity verification, credit profile lookup, and fraud prevention to deliver credit prequalification results in real time via a cloud-based system. The system may streamline the process for end users (e.g., customers) and stakeholders (e.g., lenders, retailers, and/or service providers working on behalf of a lender or retailer) by requiring only minimal data input from end users while maintaining data accuracy and security. This approach is fundamentally about requiring (and trusting) minimal information from the user by integrating the processes of identity verification, credit profile lookup, and fraud prevention. The advantages of the system described herein, in comparison to a system with a similar purpose and which includes the same or similar components without integrating the processes as is done in this invention, are more efficient user interactions, more accurate data collection, and more opportunities to flag potential fraud.

In some embodiments of the invention, an identification authentication process obtains an already-verified phone number (e.g., when the user's possession of the phone number is implicitly verified by interactions which take place via this phone number, e.g., text messages or an audio phone call), then obtains additional identification information about the user based on this phone number from a data provider, and then proceeds through credit profile lookup with minimal user confirmation of this additional information.

In some embodiments of the invention, an identification authentication process may include a one-time passcode (OTP) to efficiently verify the identity of the customer (e.g., as the owner of a given phone number). In short, the identification authentication process is performed/orchestrated by a digital experience platform (e.g., host platform server) via a web-based application at a user's mobile device. The system first prompts a user to enter an identification phone number (e.g., mobile phone number) for a precise ID verification. The system will verify the user's access to the phone number by sending a one-time passcode (OTP) to the entered mobile phone number (e.g., via text, voice call, etc.), and prompting the user to enter the OTP. After receiving the correct OTP, the system will consider the phone number to be verified

In some embodiments of the invention, once the system obtains a verified phone number belonging to the user (i.e. it either obtains an unverified phone number and then verifies it, or obtains an already-verified phone number), it performs a reverse phone look up (e.g., via a third-party data provider) to obtain externally-verified identity data based on the verified phone number (e.g., the phone number's owner's name and address). The host system may then request and obtain credit profile and other information associated with the user (e.g., a credit soft inquiry, also referred to as a “soft pull”).

Some embodiments of the invention include software programs and graphical user interfaces (GUIs) for managing the authentication process that provides an authentication using a one-time password (OTP) that is sent to a user's mobile device. Following the three-step authentication, the authentication system may then send the verified user information to a credit prequalification engine or trade-in equity engine as part of a process associated other financial services like credit prequalification for shop-by-payment, get prequalified, or single-product prequalification, or credit-enhanced valuation of trade-in equity, and other related services.

Some embodiments of the invention include an initial step for generating a one-time passcode (OTP) that validates a user's possession of a given phone number and eliminates the need for conventional passwords where most people do not want to remember a complicated password, and often people forget their crucial passwords to specific sites. Moreover, each time the user interacts with the host platform an authentication may be used. Other credit prequalification services require the user to input personal information such as name, address, phone number, electronic mail, and the like, to begin the process. Such credit prequalification services, which trust user-entered personal information, allow anyone with the information to get prequalified without verifying it is the person entering the information, creating opportunities to initiate fraudulent financial transactions. In contrast, the identification authentication process described herein can prevent and/or flag such fraudulent activity by integrating verification of the identity of the user as an inherent part of the process.

Some embodiments of the invention include a reverse phone lookup step. For example, once the user ID is verified, the reverse phone lookup step uses a reverse phone lookup API service to obtain the user's name and address associated with the verified phone number previously obtained. This enables more accurate data collection and helps eliminate traditional form fill abandonment that other credit prequalification tools and services currently use. Form abandonment is a critical “problem” when driving conversion. In the financial industry, the form abandonment rate is a staggering 76% making it one of the industries with the highest form abandonment rate. Most abandonment is because of security concerns, and forms usually require applicants to enter sensitive, personal information.

Some embodiments of the invention include a fraud detection process. The fraud detection process may use user information from a reverse phone lookup, allowing the system to conditionally perform additional identity verification at this step (such as driver's license upload/verification). For example, this integrated and conditional approach may yield benefits by allowing the identification system to use additional identity verification in some cases, but not others. In other words, if the system is proceeding with user information not substantially changed from the reverse phone lookup, the system can opt not to perform additional verification (which would increase form abandonment as well as increase costs for the stakeholder and may be deemed unnecessary when the user information comes from a trusted source). If the system is proceeding with user information provided by the user, or substantially changed from the reverse phone lookup by the user, the system can opt to perform additional verification (which helps mitigate the higher risk of fraud associated with trusting user-entered data).

Some embodiments of the invention include a credit profile lookup process (e.g., a “soft pull”) from a credit data provider, such as a credit profile, and the like. Once the user verifies the identity pulled from the RPL, the host platform receives credit profile data through an API from a credit profile reseller or directly from the credit profile. This consumer credit data further confirms the validity of the identity earlier obtained, and drives various financial services and products like single-product prequalification, shop-by-payment, get prequalified, credit-enhanced trade-in equity valuation, and others. In some implementations, a soft-pull credit profile lookup is more consumer friendly than a hard-pull as it doesn't affect their credit score and can avoid them being solicited for other finance-related products and services.

In another embodiment, the technology in this patent application is related to systems and methods for a credit prequalification process for shop-by-payment, get prequalified, single-product, prequalification, and other related services via a prequalification engine. In short, the credit prequalification process is performed/orchestrated by a digital experience platform (e.g., host platform server) via a web-based application at a user's mobile device to provide a quick and easy credit prequalification service, and provide compliance in the marketing of financial products and services. The prequalification engine is the credit decisioning engine that powers host platform credit prequalification payments, products, and services. Unlike other industry services that use a credit score, the prequalification engine is a robust engine that can ingest hundreds of rates, credit rules and guidelines to determine user credit qualifications. The prequalification engine determines which participating lender in the waterfall is most apt to approve a user for credit and at what interest rate.

Because of its machine learning capabilities, the prequalification engine can determine (e.g., predict) a rate for lending programs which do not have published rate sheets. These types of lending programs use risk-based data and proprietary logic to determine the qualifying rate for each user. Receiving an actual (non-predicted) rate from these lending programs requires a credit application submission with a proposed deal structure, followed by a hard credit pull, before an interest rate is returned for each participating lender; this is not appropriate for users who are still early in their shopping process and have not decided on a specific item to purchase and/or have not decided on a specific lender or lending program to finance the purchase, so a predicted rate is the only way to consider such lending programs for users at this stage in their shopping process. In the wake of the FTC CARS rule, it's imperative to advertise accurate interest rates and monthly payments to consumers. Other required compliance from other jurisdictions may be included.

In another embodiment, the technology in this patent application is related to systems and methods for a credit-enhanced valuation process for trade-in equity and other related services via a trade-in equity engine. In short, the credit-enhanced valuation process is performed/orchestrated by a digital experience platform (e.g., host platform server) via a web-based application at a user's mobile device to provide a quick and easy valuation service, and provide compliance in the marketing of financial products and services. The trade-in equity engine powers host platform valuation services, which are of direct value to consumers, and are also utilized as part of other host platform services to calculate accurate payments. Unlike other industry services that are not credit-enhanced, the trade-in equity engine requires minimal user input to identify candidate trade-in items owned by the user, as well as to determine the amount of any loans and liens against a given trade-in item. The trade-in equity engine determines the trade-in value and net equity of an indicated trade-in item.

Some embodiments of the invention include interacting with the user conversationally through external communication media, rather than the use of GUIs. For instance, the system may use an application programming interface (API) to send and receive communication to/from the user through one or more communication platforms (e.g., text messages, audio phone calls, social media messaging, email, etc.), through which it prompts the user and obtains the information needed for the processes described herein. In other embodiments, the system may use an API to request or receive the information needed for the processes described herein via a service provider which obtains this information conversationally through such communication platforms. When such conversational communication takes place via a platform which inherently relies on a phone number (e.g., text messages, audio phone calls, social media/text applications, etc.), the system may consider the phone number implicitly verified (“already-verified”) when the processes described herein begin.

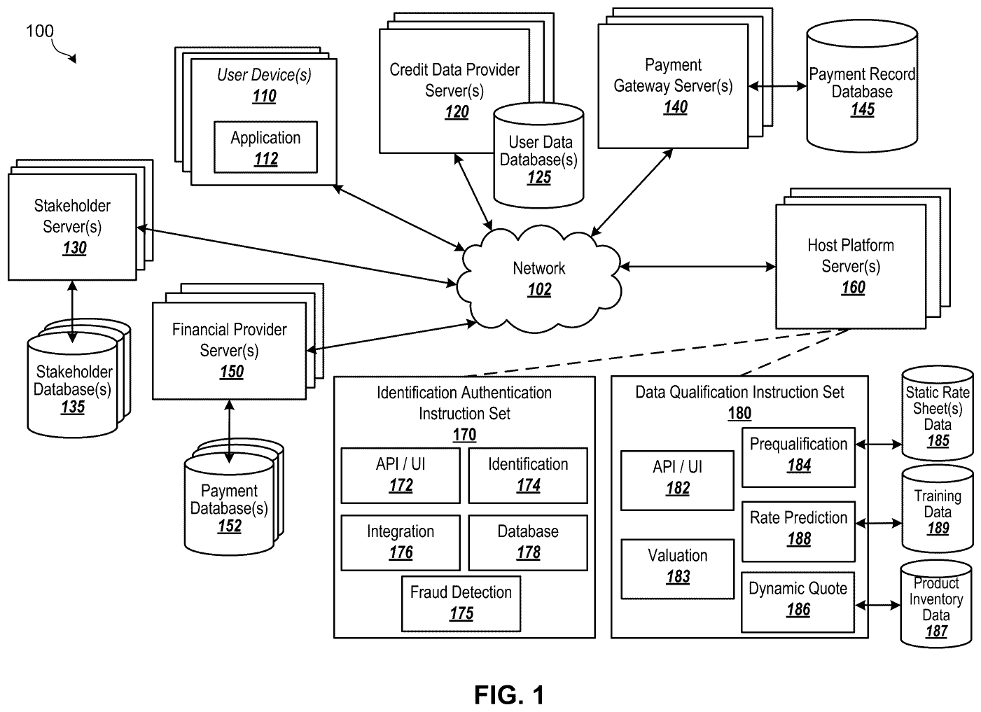

FIG. 1 is an example operating environment 100 for implementing an identification authentication process and a data qualification process, according to embodiments of the invention. The example operating environment 100 includes one or more user device(s) 110, one or more credit data provider server(s) 120, one or more stakeholder server(s) 130, one or more payment gateway server(s) 140, one or more financial provider server(s) 150, and one or more host platform server(s) 160, that communicate over a data communication network 102, e.g., a local area network (LAN), a wide area network (WAN), the Internet, a mobile network, or a combination thereof.

The one or more user device(s) 110 (e.g., a device used by a user, i.e., a client/customer seeking credit prequalification and/or credit-personalized financing quotes while shopping for vehicles) can include a desktop, a laptop, a server, or a mobile device, such as a smartphone, tablet computer, wearable device (e.g., smartwatch), in-car computing device, and/or other types of mobile devices. Additionally, the one or more user device(s) 110 may be public user devices such as a kiosk, a user terminal, and the like. The one or more user device(s) 110 includes applications, such as the application 112, for managing credit check requests to/from any of the entities associated with the servers 120, 130, 140, 150, and 160 associated with the identification authentication process and/or the data qualification process disclosed herein. The one or more user device(s) 110 can include other applications. The one or more user device(s) 110 may initiate an identification verification request or execute or at least initiate data qualification processes via application 112. The one or more user device(s) 110 may be utilized by a client to visualize the identification authentication process and/or the data qualification process via an ID verification user interface. The one or more user device(s) 110 may be utilized by a client to participate in the identification authentication process and/or the data qualification process by sending and receiving conversational communication via other applications (e.g., messaging applications, social media applications, etc.).

The one or more credit data provider server(s) 120 manages between users (e.g., customers) and stakeholders (e.g., merchants selling products, such as car dealerships and the like). The one or more credit data provider server(s) 120 may be a personal computing device, tablet computer, thin client terminal, smart phone and/or other such computing device. The one or more credit data provider server(s) 120 store user data (e.g., address, phone numbers, credit data, etc.) in one or more encrypted user data database(s) 125. The one or more credit data provider server(s) 120 receive credit profile lookup requests from a stakeholder. For example, a stakeholder device executing an identification authentication for an application may operate as a remote terminal connected to credit data provider server 120, and a stakeholder agent may initiate a credit check by interfacing with the credit data provider server 120. Additionally, after a consumer confirms with a stakeholder for a credit check, a stakeholder server 130 initiates an identification authentication process with a credit data provider server 120 by sending an ID verification request.

The one or more stakeholder server(s) 130 (e.g., merchants) generally include car dealers, realtors, furniture stores, and/or other such merchants that offer products and/or services to customers that may require a credit check (e.g., large purchases). After a consumer confirms an issuance for the particular product(s), a stakeholder server 130 initiates an identification authentication process by requesting information from a user via the user device 110. Additionally, the one or more stakeholder server(s) 130 are configured to initiate payment processes with the one or more financial provider server(s) 150 via the one or more payment gateway server(s) 140 after confirming credit requests and data verification with the credit data provider server(s) 120.

The one or more stakeholder server(s) 130 may be front-end server(s) for managing, collecting, processing, and communicating credit check requests and for purchases of products/services (e.g., resource information, revenues management data, etc.), that is stored in the stakeholder database 135. Further, the one or more stakeholder server(s) 130 may be front-end server(s) for managing, collecting, processing, and communicating payment requests and identification verification data from the one or more host platform server(s) 160 to the one or more credit data provider server(s) 120.

The one or more payment gateway server(s) 140 manages the payment transactions received from application 112 between the one or more user devices 110 and the financial provider server(s) 150 that access payment records and associated data via the payment record database 145. The management protocols of the one or more payment gateway server(s) 140 may be based on a redundant load-balancing system by managing multiple clients (e.g., user device(s) 110) so that a payment associated with a travel booking request is handled by one of the one or more financial provider server(s) 150. For example, there may be multiple financial provider server(s) 150 that are able to service the travel booking payment, and the redundant load-balancing system of the payment gateway server(s) 140 is responsible for ensuring that the travel booking request is performed by one of the capable financial provider server(s) 150. Payment processors include for example, a credit/debit card issuer, a bank, digital payment service, etc., and the one or more servers for each payment processor generally facilitate remote communication therewith to authenticate and/or authorize a payment via a payment gateway server 140. The payment transaction data may be stored in one or more payment database(s) 152 associated with each payment processor.

The one or more host platform server(s) 160 receives and processes the ID verification request(s) from a user device 110 associated with an entity, such as a stakeholder via a stakeholder server 130 (e.g., a merchant connecting to the host platform to initiate an ID verification). The one or more host platform server(s) 160 includes an Identification authentication instruction set 170 that performs an Identification authentication protocol according to processes described herein. The one or more host platform server(s) 160 also includes a data qualification instruction set 180 that performs a data qualification integration protocol according to processes described herein. The Identification authentication instruction set 170 and the data qualification instruction set 180 may include a plurality of modules.

The identification authentication instruction set 170 includes one or more modules (e.g., API/UI module 172, identification module 174, integration module 176, database module 178, fraud detection module 175, etc.) that integrate a plurality of Identification authentication services and thus require a complex orchestration aspect. In an exemplary embodiment, the identification authentication process for the Identification authentication instruction set 170 is based on the following steps. First, users (e.g., customers) may access an identification authentication module (e.g., API/Portal module 172) on a stakeholder's website via an authentication portal on the host platform (e.g., integration with credit data provider server(s) 120 via integration module 176). Users can then enter an identification (e.g., phone number) and, if prompted, provide a one-time passcode for verification (e.g., via an identification module 174). The host platform may be able to retrieve some previously stored user and/or stakeholder data via one or more databases (e.g., via database module 178). In an exemplary embodiment, the fraud detection module 175 may utilize a configurable variety of methods to detect and flag potential fraudulent inputs or activity based on historical and real-time data, including optionally third-party services and/or machine learning.

The data qualification instruction set 180 includes one or more modules (e.g., API/user interface module 182, prequalification module 184, dynamic quote module 186, rate sheet (machine learning) module 188, etc.) that integrates a plurality of data qualification services and thus require a complex orchestration aspect in order to provide a complete end-to-end, self-service process flow to get connected to the host platform. In an exemplary embodiment, the process for the data qualification instruction set 180 is based on receiving the verified user information from the Identification authentication instruction set 170 (e.g., a credit profile lookup) and sending the information to an engine requiring credit profile data, that may include four different processes associated other financial services like credit prequalification for shop-by-payment, get prequalified, single-product, prequalification, and other related services via a prequalification engine, and like credit-enhanced valuation for trade-in equity via a trade-in equity engine. For example, based on the data filled by the user and the credit data, the host platform may generate different tools for the user or stakeholder to be connected to the host platform (e.g., API, scripts, network, etc.) and to the stakeholders (e.g., via API/portal module 182). The host platform allows the user and stakeholders to access a prequalification engine (e.g., via prequalification module 184). Then the host platform may display dynamic quote information based on the data qualification (e.g., dynamic quote module 186), and determine (e.g., predict) an expected rate based on a machine learning algorithm (e.g., via rate prediction engine (machine learning) module 188) in conjunction with prequalification based on static rate sheets (e.g., via prequalification module 184). For example, the rate prediction engine (machine learning) module 188 may be trained on previously generated financing rates (include live financing rate data) from one or more training databases (e.g., training database 189) to generate a predicted rate for a current customer and/or the combination of current customer and available inventory data (e.g., from product inventory database 187). For example, because of its machine learning capabilities, the prequalification engine may determine (e.g., predict) a rate for lending programs which do not have published rate sheets.

In some implementations of the invention, one or more machine learning techniques may be utilized for the dynamic quote module 186 and/or the rate prediction engine (machine learning) module 188 such as regression, classification, neural networks, reinforcement learning, and the like. In some implementations of the invention, the one or more machine learning techniques may be utilized to predict a moving target, so traditional methods which use human intervention require ongoing human effort, and one of the hurdles to traditional methods of human-based rules for prediction is that there is no straightforward way to realize when the target has moved and more human intervention is needed to maintain accuracy.

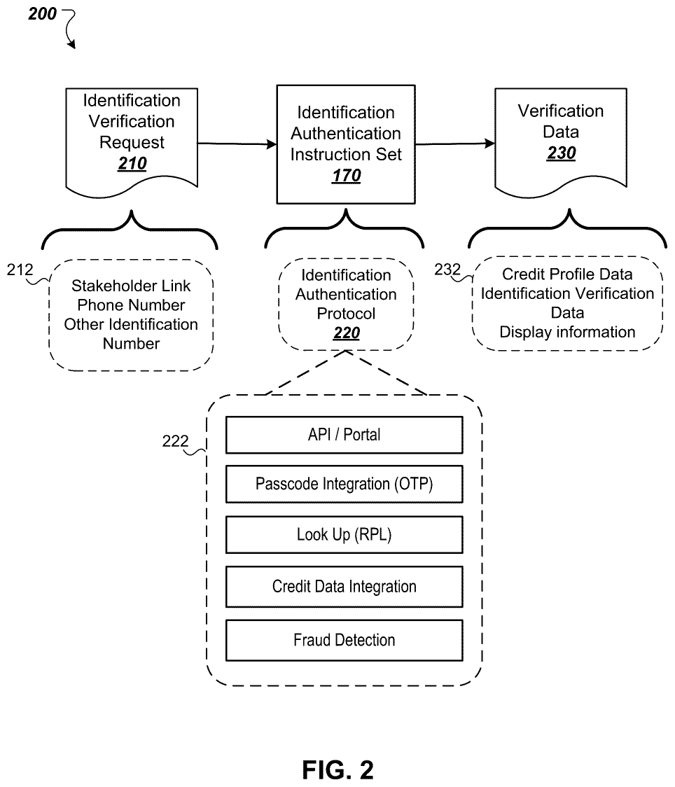

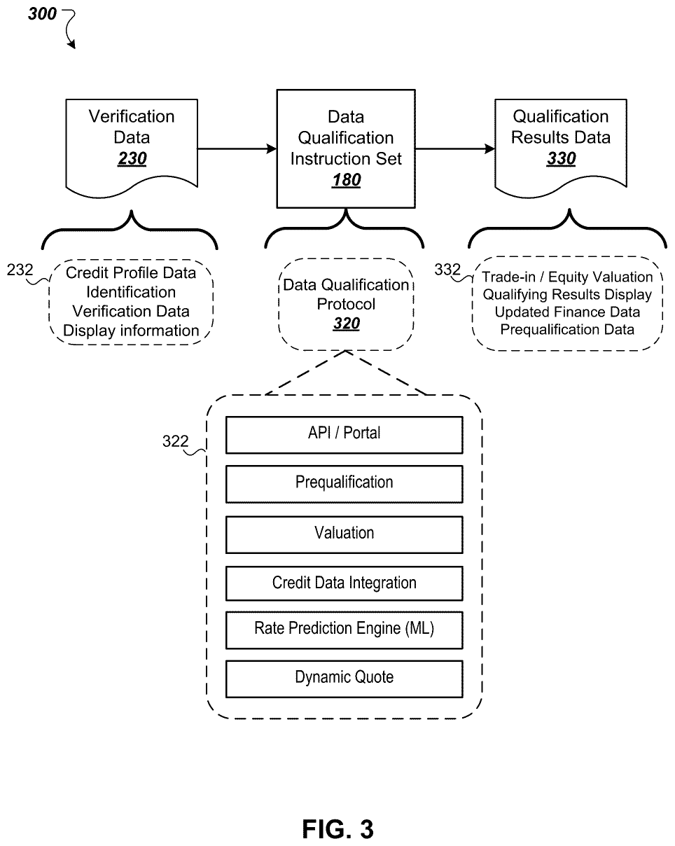

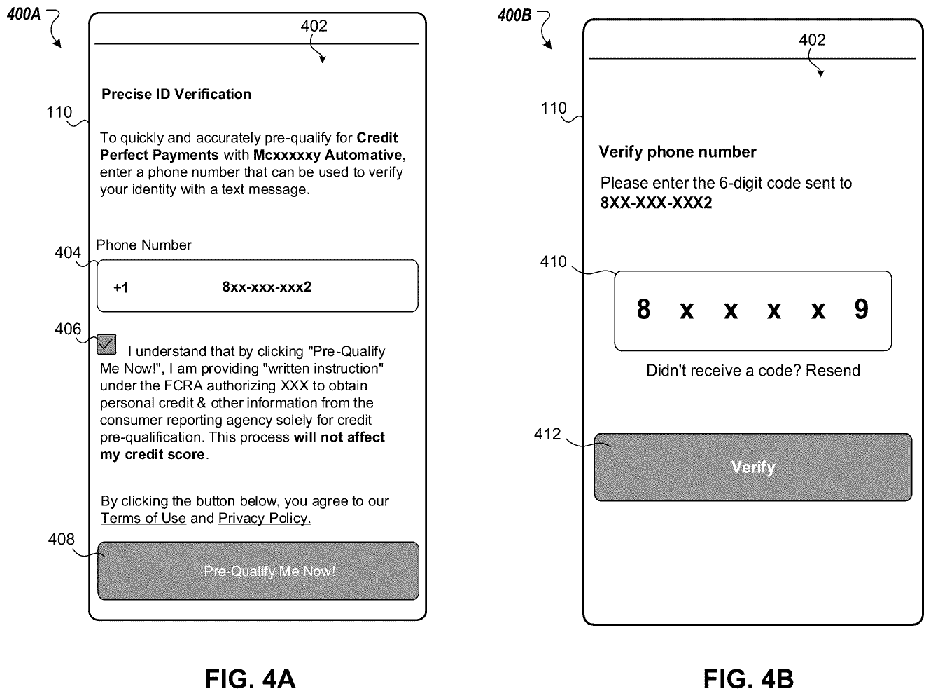

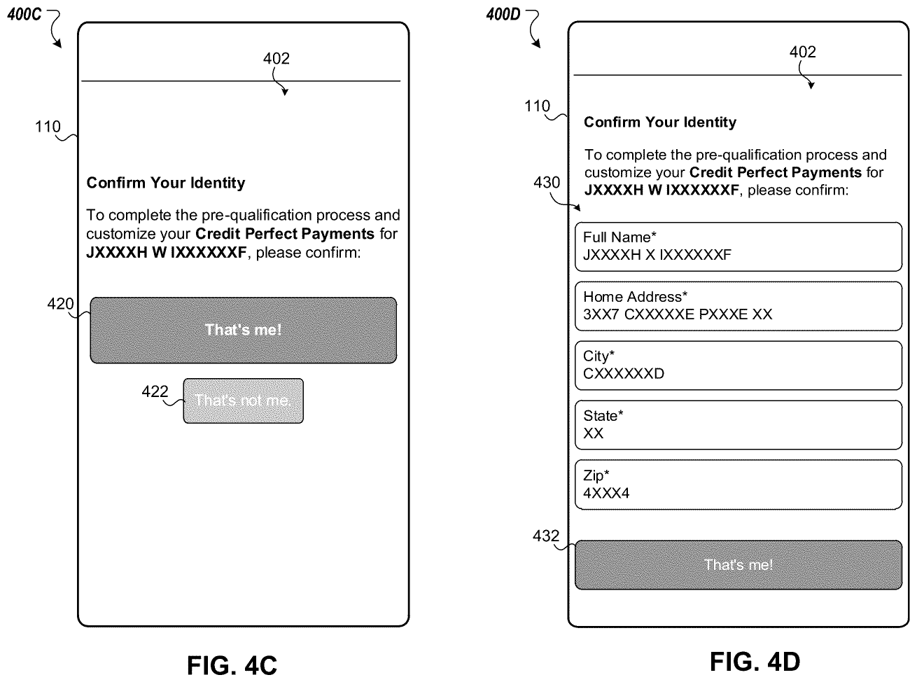

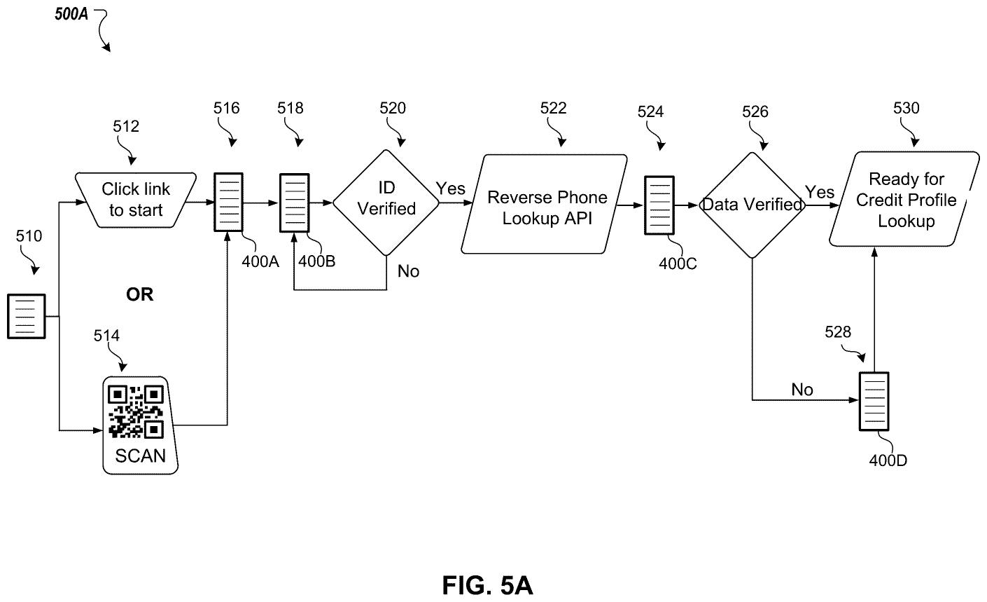

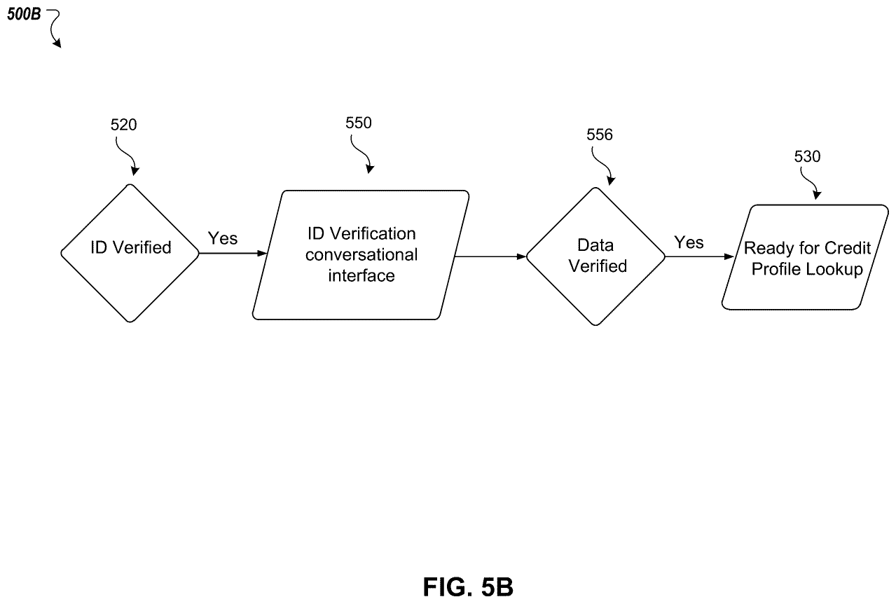

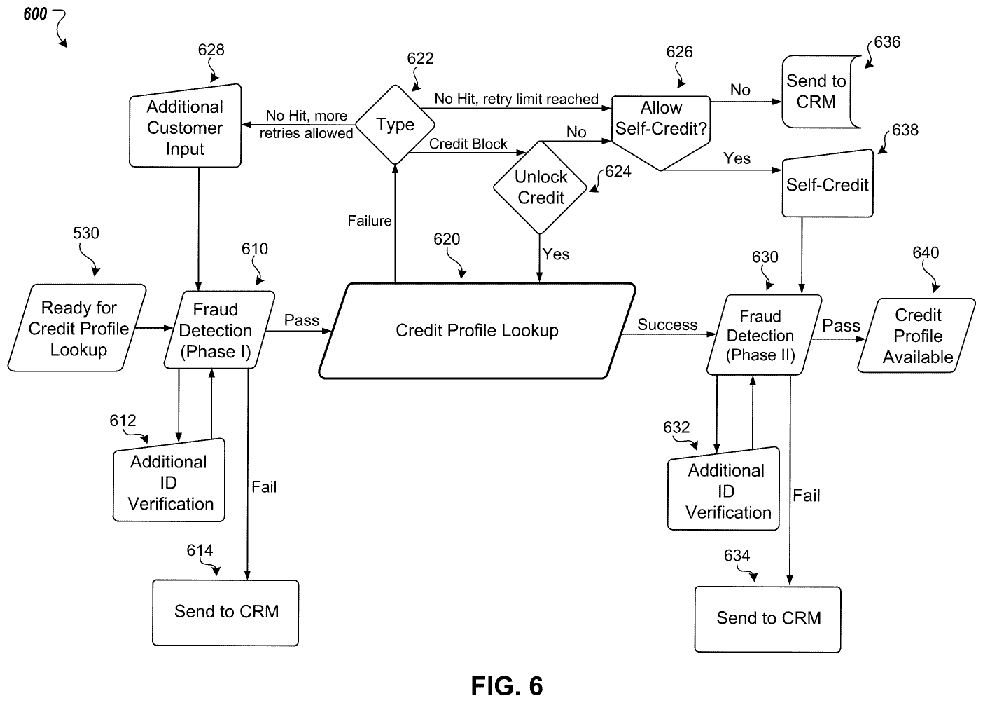

An example routine of implementing an Identification authentication process as illustrated in the environment of FIG. 1 is further discussed herein with reference to the example environments of FIG. 2, the example screenshots of FIGS. 4A-4D, and the example illustration of FIG. 5. Furthermore, an example routine of implementing a data qualification process as illustrated in the environment of FIG. 1 is further discussed herein with reference to the example environments of FIG. 3 and the example illustrations of FIG. 6-9.

FIG. 2 illustrates an example identification process based on an identification verification request, according to embodiments of the invention. In particular, FIG. 2 illustrates an example environment 200 for an identification authentication implementation for determining verification data 230 based on receiving an identification verification request 210. One objective for the identification authentication instruction set 170 is to implement an identification authentication process utilizing one or more host platform servers that are in communication with stakeholders, credit data provider systems, financial providers, and payment processors via a host platform gateway. For example, the identification authentication instruction set 170, stored on one or more host platform server(s) 160, receives an identification verification request 210 (e.g., from a stakeholder device such as a stakeholder server 130, or a client device via stakeholder server 130, a consumer request via a user device 110, and the like). The identification verification request 210 may include identification information 212 (e.g., a stakeholder link, a phone number, other identification information, etc.) that is associated with a selected marketplace for a search request.

The identification authentication instruction set 170 initiates an identification authentication protocol 220 to generate verification data 230. The verification data 230 may include verification information 232 such as credit profile data, identification verification results, and/or display information. The identification authentication protocol 220 includes, for example, one or more modules 222 to perform a plurality of services. For example, an API/portal module (e.g., API/UI module 172) to manage the generation and connection of the API between one or more entities (e.g., stakeholders connected to a plurality of financial providers) and provides and/or updates a client interface, such as a GUI, for user devices to access. The identification authentication protocol 220 may further include a passcode integration module (e.g., identification module 174) that generates and provides the one-time pass code to the user device (e.g., via text, email, automated voice call, etc.). The identification authentication protocol 220 may further include a look up module (RPL) (e.g., identification module 174) that provides the integration to a reverse phone lookup API service (e.g., via a credit data provider) to obtain the user's name and address associated with the phone number. The identification authentication protocol 220 may further include a credit data integration module (e.g., integration module 176) that provides integration with credit data provider server(s) 120. The identification authentication protocol 220 may further include a fraud detection module (e.g., fraud detection module 175) that provides a configurable variety of methods to detect and flag potential fraudulent inputs or activity based on historical and real-time data, including optionally third-party services and/or machine learning.

FIG. 3 illustrates an example data qualification process based on receiving verification data, according to embodiments of the invention. In particular, FIG. 3 illustrates an example environment 300 for a data qualification implementation for determining qualification results data 330 based on receiving verification data 230 (e.g., from FIG. 2). One objective for the data qualification instruction set 180 is to implement a data qualification process utilizing one or more host platform servers that are in communication with stakeholders, credit data provider systems, financial providers, and payment processors via a host platform gateway. For example, the data qualification instruction set 180, stored on one or more host platform server(s) 160, receives the verification data 230 (e.g., from a stakeholder device such as a stakeholder server 130, or a client device via stakeholder server 130, a consumer request via a user device 110, and the like). The verification data 230 may include credit profile data, identification verification results, and/or display information.

The data qualification instruction set 180 initiates a data qualification protocol 320 to generate qualification results data 330. The qualification results data 330 may include qualification information 332 such as notifications and/or customizations associated with trade-in/equity valuations, qualifying results data, updated finance data, prequalification data, and the like. The data qualification protocol 320 includes, for example, one or more modules 322 to perform a plurality of services. For example, an API/portal module (e.g., API/UI module 182) to manage the generation and connection of the API between one or more entities (e.g., stakeholders connected to a plurality of financial providers) and provides and/or updates a client interface, such as a GUI, for user devices to access. The data qualification protocol 320 may further include a prequalification module (e.g., prequalification module 184) that provides access to a prequalification engine for providers to perform a series of different product capabilities as further discussed herein. The data qualification protocol 320 may further include a valuation module (e.g., valuation module 183) that provides a trade-in process based on receiving the verification data 230 as further discussed herein. The data qualification protocol 320 may further include a credit data integration module (e.g., integration module 176) that provides integration with credit data provider server(s) 120. The data qualification protocol 320 may further include a rate prediction engine (ML) module (e.g., rate prediction (machine learning) module 188) that may be trained on previously generated financing rates (include live financing rate data) from one or more training databases (e.g., training database 189) to generate a predicted rates for a current customer and/or the combination of current customer and available inventory data (e.g., from product inventory database 187). The data qualification protocol 320 may further include a dynamic quote module (e.g., dynamic quote module 186) to display dynamic quote information based on the predicted expected rates from the rate prediction engine (ML) module.

FIG. 4A illustrates an example screenshot 400A for the host platform via an ID verification user interface 402 at a user device 110, according to embodiments of the invention. In particular, the example screenshot 400A illustrates an initial identification verification process (e.g., a first step in a credit prequalification process) by requesting input of identification data (e.g., enter a phone number). The ID verification user interface 402 may also be referred to herein as a “ID verification portal.” As illustrated in example screenshot 400A, the ID verification user interface 402 may include a user data entry element 404 (e.g., to enter user information such as a phone number), an authorization verification check box (e.g., element 406), and an execution button (e.g., element 408).

FIG. 4B illustrates an example screenshot 400B for the host platform via an ID verification user interface 402 at a user device 110, according to embodiments of the invention. In particular, the example screenshot 400B illustrates a one-time passcode verification process (e.g., a second step in a credit prequalification process) by requesting input of a one-time passcode (e.g., enter a 6-digit random number that was generated and provided to the user device 110 via text or by other means). As illustrated in example screenshot 400B, the ID verification user interface 402 at this stage may include a user data entry element 410 (e.g., to enter the received random number), and an execution button (e.g., element 412) to proceed with the verification of the random number entered.

FIG. 4C illustrates an example screenshot 400C for the host platform via an ID verification user interface 402 at a user device 110, according to embodiments of the invention.

In particular, the example screenshot 400C illustrates an identity confirmation process (e.g., an initial confirmation step in a credit prequalification process) by displaying an identified name associated with the data pull (e.g., a reverse phone look up). As illustrated in example screenshot 400C, the ID verification user interface 402 at this stage includes an identification confirmation execution button to verify “that's me!” (e.g., element 420) to proceed with identity confirmation if the user's name matches. Moreover, if the user does not recognize the name obtained (e.g., a phone number may be associated with a family member), the user may proceed with a subsequent identity confirmation entry stage as illustrated in FIG. 4D, by clicking on the “that's not me” button (e.g., element 422).

FIG. 4D illustrates an example screenshot 400D for the host platform via an ID verification user interface 402 at a user device 110, according to embodiments of the invention. In particular, the example screenshot 400D illustrates a subsequent and optional identity confirmation process (e.g., a subsequent confirmation step in a credit prequalification process because the user's name did not match as illustrated in FIG. 4C). As illustrated in example screenshot 400D, the ID verification user interface 402 at this stage allows the user to enter his or her additional personal data via the standard five-line data entry fields (e.g., UI area 430). As the user enters his or her information, the system may automatically prepopulate the fields for a recognized name and address, thus if the user agrees to a match, the user may engage the identification confirmation execution button to verify “that's me!” (e.g., element 432).

FIGS. 5A-10 provide example identification authentication, prequalification, and valuation processes that include one or more of the following processes: initial user input, initial identity verification, fraud detection (phase I), credit profile lookup, fraud detection (phase II), prequalification, valuation, and communication of results.

For the initial user input process, a user (e.g., a customer, such as a potential car buyer) inputs a phone number via a web form, mobile app, or retail terminal, or provides an AI persona with their phone number via any medium available to that AI persona (including, but not limited to, audio phone call, email, SMS, or web chat). The phone number serves as a key identifier to initiate the verification process. In some embodiments, such as when the user is engaging with an AI persona via audio phone or SMS, the phone number may have been communicated either explicitly a priori or implicitly when the user initiated engagement with the AI persona. In these cases, phone number is not required as an explicit input at this point. Additionally, the user input module collects the end user's consent to the prequalification process.

For the initial identity verification process, an identity verification module (e.g., identification authentication instruction set 170) may verify possession of a provided phone number. If the phone number was provided implicitly as a result of user interactions via that phone number, it may be considered verified with no further action. Otherwise, the identity verification module triggers an SMS message to the phone number, containing a One-Time Passcode. The user input module prompts the user to enter the passcode, upon successful entry of the passcode as sent to the phone number, possession of the phone number is considered verified. The identity verification module collects and confirms further identity information. The system transmits the phone number to third-party identity lookup services via API integration. The system may receive in response, verified identity data matching the phone number. If this data includes name and full residential address, the data is considered complete. Furthermore, if the verified identity data is complete, the user input module prompts the user to confirm their name, without displaying a form or prompting for other information. Alternatively, if the verified identity data is incomplete or missing, or if the user indicates the name is incorrect, the user input module prompts the user to provide or correct the acquired name and residential address. If the user provided any identity information beyond verification of phone number and confirmation of their name, and there is a significant mismatch between the independently acquired identity information and user provided information, the system flags it for further review.

For the fraud detection process (phase I), when the system acquires name and residential address information from a third-party identity lookup service, and a credit profile lookup succeeds without the user significantly changing the name and residential address information, this provides further verification that the identity information is valid (e.g., the credit profile lookup effectively verifies that the name and residential address correspond with a known identity-considered a “clean verification”). In some embodiments of the invention, the system performs additional actions for fraud detection and subsequent further identity verification of the user's identity, depending on the stakeholder's configuration. These detection and verification actions may involve third party data integrations, and/or machine learning systems. In some embodiments of the invention, fraud detection inputs may include, but are not limited to: whether the process up to this point has been a “clean verification”, user metadata (e.g., IP address, User Agent headers, age of the account owning the phone number, and the like), historical instances of known or suspected identity theft/fraud using similar identities, etc. In some embodiments of the invention, subsequent identity verification actions may include prompting the user to upload scanned identification cards/documents, prompting the user to answer questions about the identity, and others. In some embodiments of the invention, stakeholder configuration and/or machine learning may be used to decide which subsequent identity verification actions to take based on the given fraud detection inputs. In some embodiments of the invention, depending on a stakeholder's configuration, analysis of the fraud detection inputs, and the result of any subsequent identity verification actions, the system may perform one of the following processes. For example, the system may refuse to prequalify the user due to fraud risk. In this case, the user output module prompts the user to contact the stakeholder directly to continue working toward prequalification. The system may continue the process as normal from the user's perspective. In either case, the stakeholder will be notified about the assessed risk of fraud (if any) and the result of any subsequent identity verification actions taken.

For the credit profile lookup process, once the system has acquired sufficient identity information, the system initiates a credit profile lookup from a credit profile using the user's information profile. A successful credit profile lookup fetches key credit information such as score, credit history, and debt-to-income ratio; depending on the type of lookup, this data can be acquired without impacting the user's credit score. However, if there is a failure with the credit profile lookup, the system attempts further identity verification, depending on the type of failure. In some instances, the user input module may prompt the user for a birthdate or other identification information (e.g., a social security number (SSN), an individual taxpayer identification number (ITIN), and the like). In some instances, the system may prompt the user to review and correct the acquired name and residential address. For example, if the name and residential address information was previously not significantly different from the information acquired from the third-party identity lookup service, and the user provides significantly changed name and residential address information, the system may flag for further review. Having acquired additional or changed identity information, the system may attempt a credit profile lookup again. This loop of attempted credit profile lookup and prompting the user on failure may be repeated until there is a successful credit profile lookup, or the system reaches a configured limit on attempts. However, if success is never achieved, the system may refuse to prequalify the user, and a user output module may prompt the user to contact the stakeholder directly to continue working toward prequalification.

For the fraud detection process (phase II), which may be similar to fraud detection process (phase I), but is conducted after the credit profile lookup step. For example, under the fraud detection process (phase II), the user identity information may have been changed. In addition, the stakeholder's configuration may indicate that certain further identity verification actions are not to be performed unless a successful credit profile lookup happens first. Therefore, the fraud detection inputs are analyzed again, and subsequent identity verification actions may be taken. In some embodiments of the invention, the behavior of the system for the fraud detection process (phase II) may be identical or nearly identical to that described in the fraud detection process (phase I), but with additional inputs and/or possibly altered inputs, and possibly different configuration settings.

For the prequalification process, the system may use the verified identity and retrieved credit data to assess eligibility against statically preconfigured decisioning criteria such as minimum credit score threshold, months since last bankruptcy, etc. Depending on stakeholder configuration, the system may perform additional dynamic eligibility assessments, using machine learning to model whether the customer would qualify for financing from a list of stakeholder-configured lenders or lending programs, even when static decisioning criteria are not available for those lenders/programs. In some embodiments of the invention, a prequalification module may generate a financing prequalification result, indicating whether the user could reasonably be expected to qualify for financing (e.g., the “base prequalification result”). The prequalification module may also generate additional details such as an estimated maximum loan amount and estimated interest rate range.

For the prequalification process, the system may use the base prequalification result and display it in real time to the user. Based on the stakeholder's configuration, some or all of the additional details of the prequalification result may also be displayed to the user. The prequalification result, including all additional details, may be sent to stakeholders via a configured communication channel.

FIG. 5A illustrates an example of an identification authentication process 500A, according to embodiments of the invention. Operations of the identification authentication process 500A can be implemented, for example, by a system that includes one or more data processing apparatus, such as one or more host platform server(s) 160 of FIG. 1 utilizing an identification authentication instruction set 170 and utilizing one or more protocols (e.g., identification authentication protocol 220, and the like). The identification authentication process 500A can also be implemented by instructions stored on computer storage medium, where execution of the instructions by a system that includes a data processing apparatus cause the data processing apparatus to perform the operations of the identification authentication process 500A.

The identification authentication process 500A begins at stage 510 at a user device 110, or the like, where the user may click a web-based link at stage 512 (e.g., a link at a stakeholder's webpage to start a credit prequalification process), or a user scans a QRS code or other quick link code at stage 514 to start an identification authentication process. Then at stage 516 (e.g., screenshot 400A of FIG. 4A), an initial identification verification process (e.g., a first step in a credit prequalification process) is initiated by requesting input of verification data (e.g., enter a phone number). Next, at stage 518 (e.g., screenshot 400B of FIG. 4B), a one-time passcode verification process (e.g., a second step in a credit prequalification process) is initiated by requesting input of a one-time passcode (e.g., enter a 6-digit random number that was generated and provide to the user device 110 via text or by other means).

After receiving the one-time passcode from stage 518, the process 500A continues to stage 520 to verify whether the one-time passcode is entered correctly. If the one-time passcode is not entered correctly (e.g., user error entering the code), then the process 500A returns to stage 518 for the user to try and reenter the password or may provide an option for the user to request a new code and/or request the code to be sent by different methods (e.g., sent via an automated phone call). If the one-time passcode is entered correctly at stage 518, then the process 500A proceeds to stage 522 to perform the reverse phone lookup API via a data provider (or similar entity). After identifying a name associated with the entered identification number (e.g., phone number), the process 500A continues at stage 524 (e.g., screenshot 400C of FIG. 4C), and an identity confirmation process (e.g., an initial confirmation step in a credit prequalification process) is initiated by displaying an identified name associated with the data pull (e.g., a reverse phone look-up). The process 500A continues to stage 526 to determine whether the user verified the data (e.g., selected yes or no to whether the name matched). If the user selected “That's me!”, then the process 500A proceeds to stage 530 to ingest the credit data provider information (e.g., a credit profile lookup process).

However, if the user selected “that's not me”, then the process 500A continues to stage 528 (e.g., screenshot 400D of FIG. 4D), an optional identity confirmation process (e.g., a subsequent confirmation step in a credit prequalification process because the user's name did not match as illustrated in FIG. 4C). As illustrated in example screenshot 400D, the ID verification user interface 402 at this stage allows the user to enter his or her additional personal data via the standard five-line data entry fields (e.g., UI area 430), so that the user can manually enter the data. Once the user enters the data, the process 500A proceeds to stage 530 to ingest the credit data provider information (e.g., a credit profile lookup process).

FIG. 5B illustrates an example of an identification authentication process 500B, according to embodiments of the invention. Operations of the identification authentication process 500B can be implemented, for example, by a system that includes one or more data processing apparatus, such as one or more host platform server(s) 160 of FIG. 1 utilizing an identification authentication instruction set 170 and utilizing one or more protocols (e.g., identification authentication protocol 220, and the like). The identification authentication process 500B can also be implemented by instructions stored on computer storage medium, where execution of the instructions by a system that includes a data processing apparatus cause the data processing apparatus to perform the operations of the identification authentication process 500A.

The identification authentication process 500B begins at stage 520 upon receiving already-verified ID data (e.g., if the user is communicating with the system or one of the system's service providers via text, audio phone call, etc. which inherently utilizes a phone number). Then the process 500B proceeds to ID verification conversational interface 550. For example, a user may engage with an AI Persona (e.g., an AI bot) on behalf of a merchant or lender running a special financing program to assist credit-challenged users. For example, a user may initiate a search and find a special financing program, and then the user may send SMS messages to an indicated phone number to determine whether they are eligible for the financing program; an AI persona may receive that message and interact with the user via an SMS conversation. Since the AI Persona is already engaging with the customer via SMS, it is not necessary to further verify the phone number. The system may then use a third-party service successfully to look up the name and address associated with the phone number

Then the process 500B proceeds to data verified step 556 to determine whether the user verified the data (e.g., responded yes or no to whether the name matched). If the user confirms the name is correct, then the process 500A proceeds to stage 530 to ingest the credit data provider information (e.g., a credit profile lookup process).

FIG. 6 illustrates an example of a credit profile lookup process 600 based on an identification authentication from stage 530 of FIGS. 5A/5B, according to embodiments of the invention. Operations of the credit profile lookup process 600 can be implemented, for example, by a system that includes one or more data processing apparatus, such as one or more host platform server(s) 160 of FIG. 1 utilizing an identification authentication instruction set 170 and utilizing one or more protocols (e.g., identification authentication protocol 220, and the like). The credit profile lookup process 600 can also be implemented by instructions stored on computer storage medium, where execution of the instructions by a system that includes a data processing apparatus cause the data processing apparatus to perform the operations of the credit profile lookup process 600.

In other words, the credit profile of a user, such as a consumer looking to finance a large purchase (e.g., a vehicle), is acquired, further confirming the user's identity, only sometimes requiring interaction from the user either via an ID verification user interface at device 110 or via conversational communications, through the identification authentication process described herein (e.g., a credit profile lookup process).

The credit profile lookup process 600 begins at stage 610 for fraud detection (i.e., Fraud Detection Phase I, prior to acquiring credit profile data). The fraud detection at stage 610 will analyze the available inputs in accordance with the stakeholder's configuration for this phase.

If the system determines that the inputs constitute likely fraud according to the stakeholder's configuration for this phase, the inputs will “fail” this phase of fraud detection checks, in which case the system provides information about the user's inputs, likely fraud status, and other information regarding the user acquired or generated up to this point, to the stakeholder via a stakeholder's customer relationship management (CRM) system at stage 614; the system then declines to continue the credit profile lookup process 600, instead directing the user to contact the stakeholder directly (e.g., to continue prequalifying for financing). However, if instead the system determines that, according to the stakeholder's configuration for this phase, further identity verification is needed before determining whether the inputs constitute likely fraud, the credit profile lookup process 600 moves to stage 612 to conduct further ID verification actions (e.g., prompting for upload of pictures of ID cards/documents, or checking for matches of this identity against a database of identities known to be stolen or previously used in fraudulent activities, etc.), before returning to stage 610 to reanalyze the inputs with the addition of the results of these further ID verification actions. If and when the inputs pass fraud detection in stage 610, the credit profile lookup process 600 proceeds to stage 620 to attempt a credit profile lookup via a credit data provider (e.g., a soft pull, hard pull, or other credit profile lookup).

If a credit profile lookup at stage 620 is successful, the credit profile lookup process 600 proceeds to stage 630 for fraud detection (e.g., Fraud Detection Phase II, after acquiring credit profile data). Although no inputs have changed aside from the addition of credit profile data for the user, the stakeholder's configuration for this 2nd phase of fraud detection may have different requirements or actions configured than for the 1st phase of fraud detection. Similarly to stage 610, in stage 630 the system may determine the inputs “fail” this phase of fraud detection checks, in which case the system provides information about the user's inputs, likely fraud status, and other information regarding the user acquired or generated up to this point, to the stakeholder via a stakeholder's customer relationship management (CRM) system at stage 634; the system then declines to continue the credit profile lookup process 600, instead directing the user to contact the stakeholder directly (e.g., to continue prequalifying for financing). However, if instead the system determines that, according to the stakeholder's configuration for this phase, further identity verification is needed before determining whether the inputs constitute likely fraud, the credit profile lookup process 600 moves to stage 632 to conduct further ID verification actions (e.g., prompt for upload of pictures of ID cards/documents, or a check for matches of this identity against a database of identities known to be stolen or previously used in fraudulent activities), before returning to stage 630 to reanalyze the inputs with the addition of the results of these further ID verification actions. If and when the inputs pass fraud detection in stage 630, the credit profile lookup process 600 proceeds to stage 640.

If a credit profile lookup at stage 620 fails, the credit profile lookup process 600 proceeds to stage 622 to assess what action to take based on the type of lookup failure. If the failure is a “no hit” (e.g., no matching credit profile was found, or multiple distinct matching profiles were found) and the credit profile lookup has been attempted for this user less than the maximum number of times allowed by the stakeholder's configuration, the credit profile lookup process 600 proceeds to stage 628 to request additional customer input (e.g., ask for other qualifying information and/or corrections to the existing information); if additional and/or altered data is provided by the user, the credit profile lookup process 600 returns to stage 610 to perform fraud detection (Phase I) again before attempting another credit profile lookup. If the failure is a “no hit” and the credit profile lookup has been attempted for this user at least the maximum number of times allowed by the stakeholder's configuration, the credit profile lookup process 600 instead proceeds to stage 626 to determine its next action based on the stakeholder's configuration. Alternatively, if the failure assessed by stage 622 is a credit block (e.g., a “credit freeze” or “credit lock”), the credit profile lookup process 600 proceeds to stage 624 to prompt the user to unlock access to their credit profile. If the unlock is successful, the credit profile lookup process 600 returns to stage 620 to attempt another credit profile lookup; if the user is unable or unwilling to unlock their credit profile, the credit profile lookup process 600 instead proceeds to stage 626 to determine its next action based on the stakeholder's configuration.

At stage 626, the system checks stakeholder configuration to determine whether “self-credit” is allowed (i.e. untrusted/estimated credit profile details provided by the user, rather than trusted credit profile details provided by a credit data provider). If self-credit is allowed, the system prompts the user to provide estimated credit profile details, the credit profile lookup process 600 records that the credit profile details are untrusted, and the credit profile lookup process 600 proceeds to stage 630 for fraud detection (Phase II). If self-credit is not allowed, the system provides information about the user's inputs, credit profile lookup status, and other information regarding the user acquired or generated up to this point, to the stakeholder via a stakeholder's customer relationship management (CRM) system at stage 636.

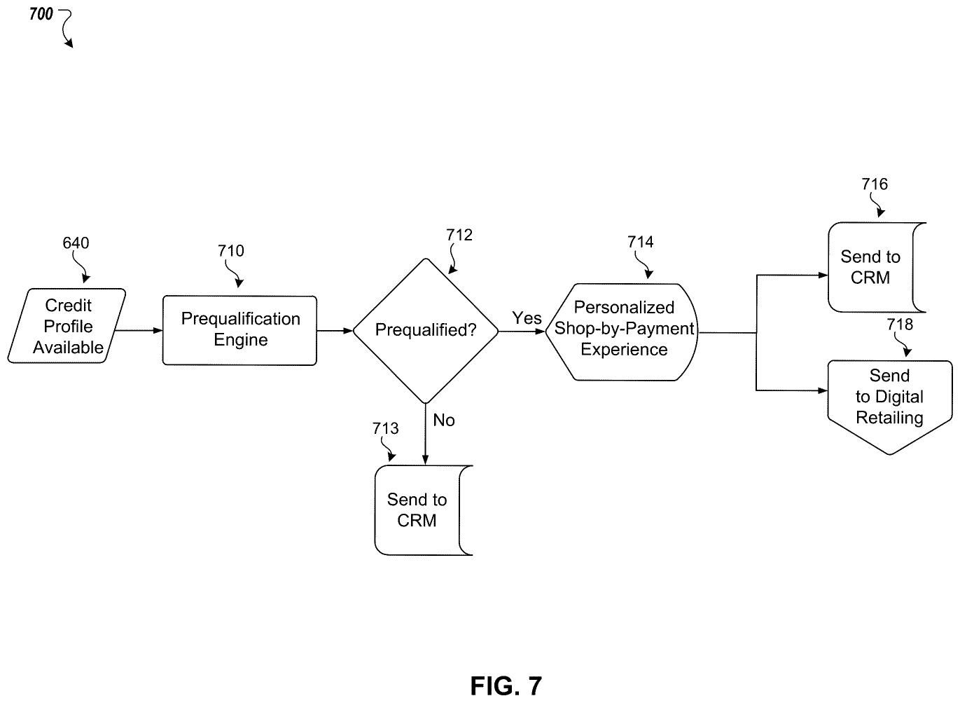

FIG. 7 illustrates an example of a prequalification process 700 based on credit profile data from stage 640 of FIG. 6, according to embodiments of the invention. Operations of the prequalification process 700 can be implemented, for example, by a system that includes one or more data processing apparatus, such as one or more host platform server(s) 160 of FIG. 1 utilizing a data qualification instruction set 180 and utilizing one or more protocols (e.g., prequalification module of the one or more modules 322 of the data qualification protocol 320, and the like). The prequalification process 700 can also be implemented by instructions stored on computer storage medium, where execution of the instructions by a system that includes a data processing apparatus cause the data processing apparatus to perform the operations of the prequalification process 700.

The prequalification process 700 (also referred to as a credit prequalification process for a “shop-by-payment” process) begins at stage 710 at a prequalification engine at a host platform server 160 (e.g., via the prequalification module 184 at the data qualification instruction set 180). The prequalification engine (e.g., a lender artificial intelligence decisioning engine), receives the ingested credit data provider information from stage 640 of FIG. 6, and generates prequalification details from this data. In other words, a user, such as a consumer looking to finance a large purchase (e.g., a vehicle), confirms his or her identity via an ID verification user interface at device 110 through the identification authentication process described herein (e.g., credit profile lookup process 600 of FIG. 6).

The prequalification process 700 continues to stage 712 to determine whether the user is prequalified or not. If the user is determined to not be prequalified, the prequalification process 700 proceeds to stage 713 to provide information about the user's inputs, prequalification status, and other information regarding the user acquired or generated up to this point, to the stakeholder via a stakeholder's customer relationship management (CRM) system. If the user is determined to be prequalified, the prequalification process 700 continues to stage 714 to show qualifying inventory items and services available for purchase (directly or indirectly) in connection with the stakeholder (e.g., vehicles, agricultural equipment, real estate, and the like) by the user based on the prequalification status and other associated information acquired from the user or generated by the prequalification engine, including estimated available monthly payments for each item or service (e.g., payments available if financed with prequalified loan or lease programs known or predicted by the system), and possibly filtered based on known or predicted preferences of the user; this is referred to as a “Personalized Shop-By-Payment Experience” (SBP). Additionally, after showing qualifying items and services to the user, the system provides information about the user's prequalification status, SBP interactions, and other information regarding the user acquired or generated up to this point, to the stakeholder via a stakeholder's customer relationship management (CRM) system at stage 716 and may provide this information to stakeholder's digital retailing system at stage 718 while directing the user to that system.

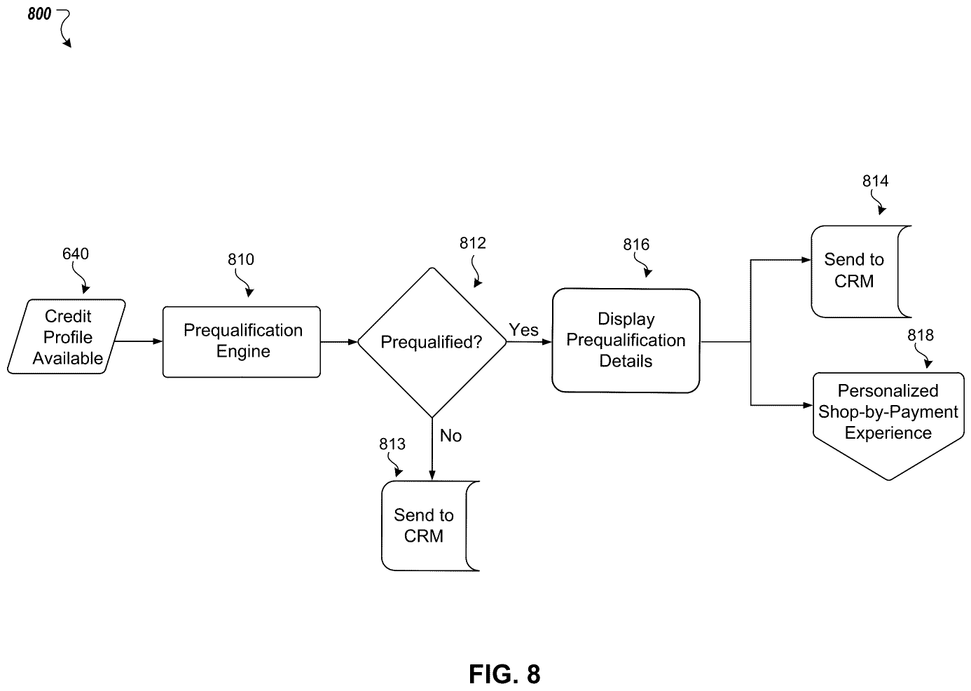

FIG. 8 illustrates an example of a prequalification process 800 based on credit profile data from stage 640 of FIG. 6, according to embodiments of the invention. Operations of the prequalification process 800 can be implemented, for example, by a system that includes one or more data processing apparatus, such as one or more host platform server(s) 160 of FIG. 1 utilizing a data qualification instruction set 180 and utilizing one or more protocols (e.g., prequalification module of the one or more modules 322 of the data qualification protocol 320, and the like). The prequalification process 800 can also be implemented by instructions stored on computer storage medium, where execution of the instructions by a system that includes a data processing apparatus cause the data processing apparatus to perform the operations of the prequalification process 800.

The prequalification process 800 (also referred to as a credit prequalification process for a “get prequalified” process) begins at stage 810 at a prequalification engine at a host platform server 160 (e.g., via the prequalification module 184 at the data qualification instruction set 180). The prequalification engine (e.g., a lender artificial intelligence decisioning engine), receives the ingested credit profile data from stage 640 of FIG. 6, and generates prequalification details from this data. In other words, a user, such as a consumer looking to finance a large purchase (e.g., a vehicle), confirms his or her identity via an ID verification user interface at device 110 through the identification authentication process described herein (e.g., a credit profile lookup process).

After receiving the ingested credit data provider information from stage 640, the prequalification process 800 continues to stage 812 to determine whether the user is prequalified or not. If the user is determined to not be prequalified, the process 800 proceeds to stage 813 to provide information about the user's inputs, prequalification status, and other information regarding the user acquired or generated up to this point, to the stakeholder via a stakeholder's customer relationship management (CRM) system to the stakeholder via the stakeholder's CRM system. If the user is determined to be prequalified, the prequalification process 800 continues to stage 816 to send prequalification details to the user, either via a user interface at user device 110, or via conversational communications which may be received at user device 110.

After sending prequalification details to the user at stage 816, the process proceeds to stage 814 to provide this consumer's prequalification information, and other information regarding the user acquired or generated up to this point, to the stakeholder via the stakeholder's CRM system, and may provide the user with access to a personalized shop-by-payment experience at stage 818.

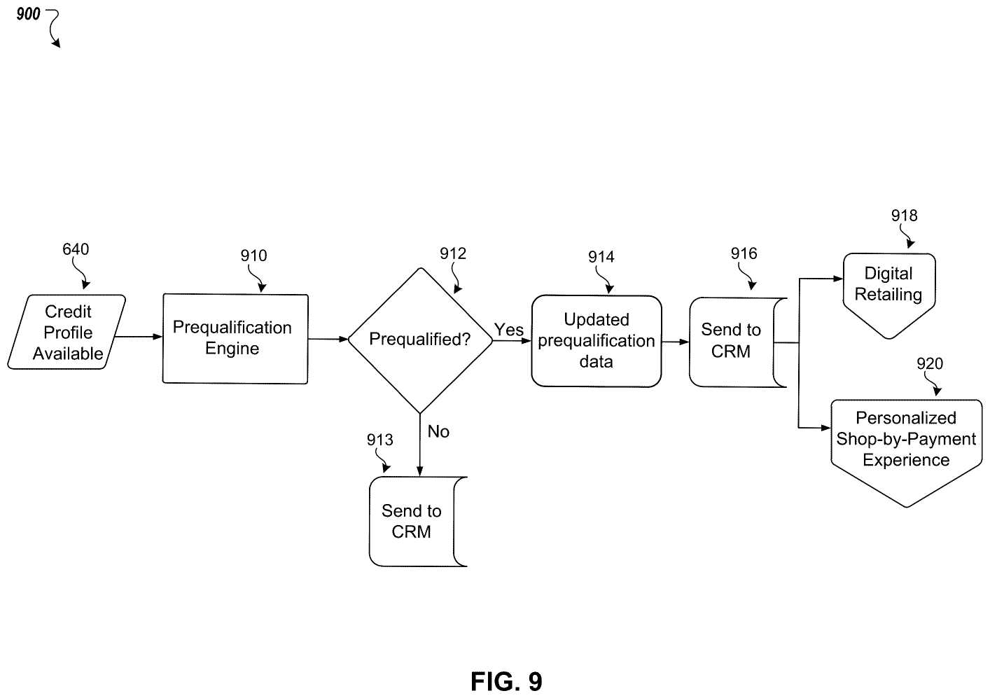

FIG. 9 illustrates an example of a prequalification process 900 based on credit profile data from stage 640 of FIG. 6, according to embodiments of the invention. Operations of the prequalification process 900 can be implemented, for example, by a system that includes one or more data processing apparatus, such as one or more host platform server(s) 160 of FIG. 1 utilizing a data qualification instruction set 180 and utilizing one or more protocols (e.g., prequalification module of the one or more modules 322 of the data qualification protocol 320, and the like). The prequalification process 900 can also be implemented by instructions stored on computer storage medium, where execution of the instructions by a system that includes a data processing apparatus cause the data processing apparatus to perform the operations of the prequalification process 900.

The prequalification process 900 (also referred to as a credit prequalification process for a “single-product prequalification” process) begins at stage 910 at a prequalification engine at a host platform server 160 (e.g., via the prequalification module 184 at the data qualification instruction set 180). The prequalification engine (e.g., a lender artificial intelligence decisioning engine), receives the ingested credit data provider information from stage 640 of FIG. 6. In other words, a user, such as a consumer looking to finance a large purchase (e.g., a vehicle), confirms his or her identity via an ID verification user interface at device 110 through the identification authentication process described herein (e.g., a credit profile lookup process).

After receiving the ingested credit data provider information from stage 640, the prequalification process 900 continues to stage 912 to determine whether the user is prequalified or not. If the user is determined to not be prequalified, the prequalification process 900 proceeds to stage 913 to provide information about the user's inputs, prequalification status, and other information regarding the user acquired or generated up to this point, to the stakeholder via a stakeholder's customer relationship management (CRM) system. If the user is determined to be prequalified, the prequalification process 900 continues to stage 914 to send updated prequalification data to the user, in particular as relevant to a single inventory item or service in which the user previously indicated interest (e.g., providing estimated monthly payments and other details about prequalified loan and lease programs available to the user based on customer credit and based on the decisioning block via the prequalification engine based on configured and predicted financing programs). After sending updated prequalification data to the user at stage 914, the prequalification process 900 continues to stage 916 to provide information about the user's inputs, prequalification status, and other information regarding the user acquired or generated up to this point, to the stakeholder via a stakeholder's customer relationship management (CRM) system. The prequalification process 900 then continues to stage 918 where the process may provide this information to the stakeholder's digital retailing system while directing the user to that system, and/or may provide the user with access to a Personalized Shop-By-Payment Experience for qualifying inventory items and services available for purchase (directly or indirectly) in connection with the stakeholder (e.g., vehicles, agricultural equipment, real estate, and the like) by the user based on the prequalification status and other associated information acquired from the user or generated by the prequalification engine. This may include estimated available monthly payments for each item or service (e.g., payments available if financed with prequalified loan or lease programs known or predicted by the system), and/or filtered items and services which are believed to be similar or complementary to the item or service in which the user has previously shown interest at stage 920.

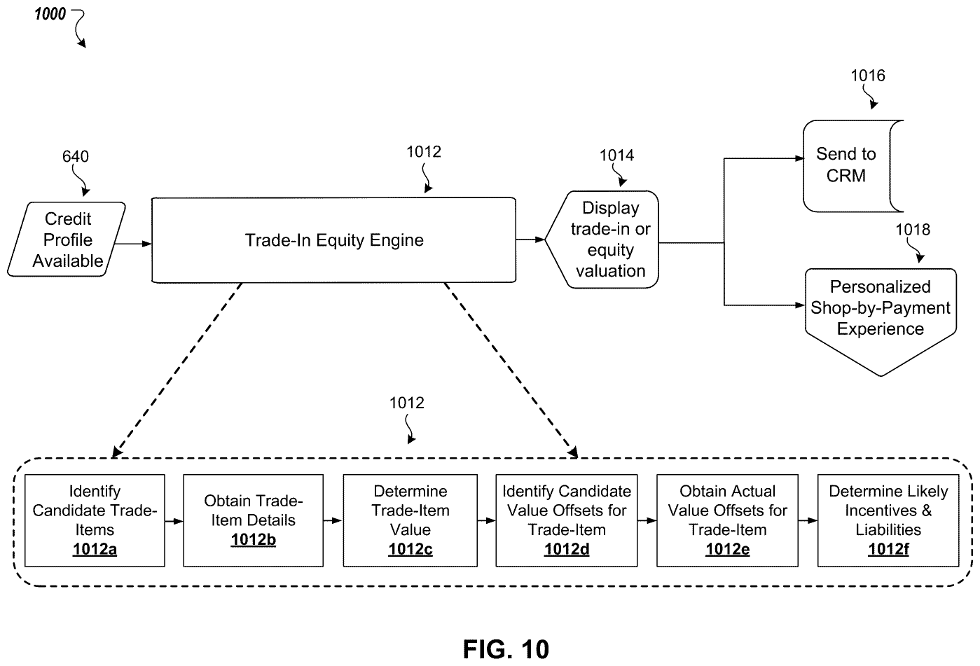

FIG. 10 illustrates an example of a valuation process 1000 based on a credit profile availability determination from stage 640 of FIG. 6, according to embodiments of the invention. Operations of the valuation process 1000 can be implemented, for example, by a system that includes one or more data processing apparatus, such as one or more host platform server(s) 160 of FIG. 1 utilizing a valuation module 183 at data qualification instruction set 180 and utilizing one or more protocols (e.g., valuation module of the one or more modules 322 of the data qualification protocol 320, and the like). The valuation process 1000 can also be implemented by instructions stored on computer storage medium, where execution of the instructions by a system that includes a data processing apparatus cause the data processing apparatus to perform the operations of the valuation process 1000.

The valuation process 1000 (also referred to as a credit enhanced process for a “trade-in” process) begins at a trade-in equity engine 1012 provided by a host platform server 160 (e.g., via the valuation module 183 at the data qualification instruction set 180). The trade-in equity engine (e.g., an orchestration and calculation engine for determining trade-in equity), receives the ingested identification and credit profile data from stage 640 of FIG. 6, and generates an estimated net value of an item owned by the user, if offered for sale or trade, along with details of external incentives and liabilities which may be available or incurred as part of or as a result of such a transaction (e.g., credits or liabilities related to sales tax or capital gains tax, manufacturer or retailer rebates, etc.). In other words, a user, such as a consumer looking to trade-in a product (e.g., a vehicle, artwork, etc.), confirms his or her identity via an ID verification user interface at device 110 through the identification authentication process described herein (e.g., a credit profile lookup process), and in doing so allows the system to determine eligible trade-in items the user owns, as well as loans or liens which may reduce the trade-in equity of such items, as well as applicable rebates or tax implications which may indirectly impact the value in the context of a sale or trade transaction, with less required user input and/or increased accuracy (e.g., in comparison to similar systems which serve a similar function but without the benefit of integrating the identification authentication process of this invention). The trade-in equity engine 1012 is composed of multiple stages (1012a through 1012f).

In stage 1012a, the valuation process 1000 identifies candidate trade-items owned by the user, based on the identification data from process 500A or 500B; this may involve retrieving data via an API from a data provider entity. For example, depending on the type of trade-items relevant to the stakeholder, the process may retrieve the VINs and descriptions of vehicles currently registered at the address of the user, the addresses of real estate owned by the user, or a list of notable artwork owned by the user.

After identifying candidate trade-items in stage 1012a, the valuation process 1000 continues to stage 1012b to determine relevant details about the trade-item the user wishes to value. The system prompts the user to select one of the candidate trade-items identified in 1012a, and/or provide details about the trade-item to be valued. For example, the user can be shown a list of identified candidate vehicles; the user may select one of these, enter the VIN of another vehicle not shown, or provide details (e.g., year, make, model, and trim) of a non-specific vehicle. To minimize the data requested from the user (and avoid potential inaccuracies in such data), the valuation process may then retrieve more information about the specified trade-item from a data provider entity (e.g., retrieve year, make, model, trim, and other details about a vehicle based on the VIN provided by the user). If necessary for accurate valuation, the system then prompts the user to provide missing details about the trade-item (e.g., information about the condition of a vehicle). These interactions with the user may take place either via a user interface at device 110, or via conversational communications which the user may send and receive at device 110.

Upon obtaining sufficient information about the trade-item for accurate valuation, the valuation process 1000 continues to stage 1012c to determine the estimated independent value of the trade-item, based on the obtained data about this trade-item; this may involve retrieving data from one or more data provider entities.

Upon obtaining the estimated independent value of the trade-item, the valuation process 1000 continues to stage 1012d to identify candidate value offsets for the trade-item, such as loans or liens associated with the specific trade-item; this data may be obtained from the ingested credit profile data, and/or from data retrieved from one or more data provider entities. In cases where candidate value offsets are identified but may not be definitively associated with the specific trade-item, the valuation process 1000 may use data obtained about the specific trade-item to determine which of the candidate value offsets are likely to be associated with the specific trade-item.

Upon obtaining candidate value offsets for the trade-item, the valuation process 1000 continues to stage 1012e to obtain actual value offsets for the trade-item. The system prompts the user to indicate which of the candidate value offsets are associated with the trade-item, and/or to enter the amount of other value offsets associated with the trade-item. These interactions with the user may take place either via a user interface at device 110, or via conversational communications which the user may send and receive at device 110.

Upon obtaining the actual value offsets for the trade-item, the valuation process 1000 continues to stage 1012f to determine incentives and liabilities likely to be available/incurred by a sales or trade transaction involving this trade-item, based on one or more of the following: the estimated independent value of the trade-item, the total of any value offsets of the trade-item, relevant laws governing the transaction (which may vary based on the identification data of the user and/or obtained details about the trade-item), and other data which the process may obtain at this stage from data provider entities. For example, the valuation process 1000 may retrieve the date and value of a prior sale of the trade-item from a data provider entity, and determine a likely capital gains tax liability or capital loss tax deduction based on the difference between the prior sale value and the estimated independent value of the trade-item as well as the date of the prior sale. For another example, the valuation process 1000 may identify an available sales tax deduction for the purchase of a vehicle if another vehicle is traded as part of the transaction, based on the location of the vehicle's registration and/or the location of the transaction (e.g., the stakeholder's location). For another example, the valuation process 1000 may identify a loyalty rebate offered by a vehicle manufacturer for the purchase of a new vehicle produced by that manufacturer when paired with the trade-in of a vehicle produced by that same manufacturer.

Once all the stages 1012a through 1012f have completed, all the valuation details generated by those stages will be made available to subsequent stages. For instance, the estimated net equity of the trade-item (its estimated independent value less any value offsets) and any conditional incentives and liabilities may be used in a personalized shop-by-payment experience in stage 1018 to improve the completeness and accuracy of payments calculated therein.

After the trade-in equity engine 1012 generates valuation details, the valuation process 1000 continues to stage 1014 to display the trade-in or equity valuation to the user (e.g., via a user interface at the user device 110, or via conversational communications which may be received at user device 110).

After displaying the trade-in or equity valuation to the user at stage 1014, the valuation process 1000 continues to stage 1016 to provide this trade-in information, and other information regarding the user acquired or generated up to this point, to the stakeholder via the stakeholder's CRM system, and the valuation process 1000 provides the user with access to a personalized shop-by-payment experience at stage 1018.

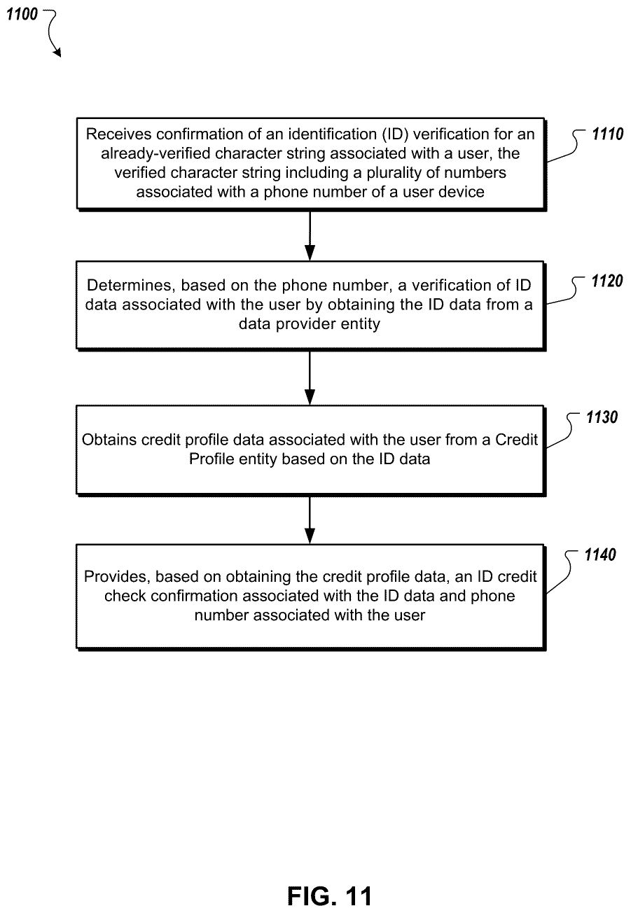

FIG. 11 illustrates a flowchart of an example process 1100 for implementing and providing an identification authentication process, according to embodiments of the invention. Operations of the process 1100 can be implemented, for example, by a system that includes one or more data processing apparatus, such as one or more host platform server(s) 160 of FIG. 1 utilizing an identification authentication instruction set 170 and utilizing one or more protocols (e.g., identification authentication protocol 220, marketplace notification protocol 250, and the like). The process 1100 can also be implemented by instructions stored on computer storage medium, where execution of the instructions by a system that includes a data processing apparatus cause the data processing apparatus to perform the operations of the process 1100.

The system, at a device that includes one or more processors, receives confirmation of an identification (ID) verification for an already-verified character string associated with a user, the verified character string including a plurality of numbers associated with a phone number of a user device (1110). For example, a host platform may provide access to the system via an ID verification user interface 402 via a user device 110. In some implementations of the invention, the host platform is accessed via an ID verification user interface. In some implementations of the invention, the host platform is accessed by a stakeholder's or other service provider's system via an application program interface (API).

The system determines, based on the phone number, a verification of ID data associated with the user by obtaining the ID data from a data provider entity (1120). For example, the system may use a verified phone number to obtain and verify name/address information of the user.

The system obtains credit profile data associated with the user from a credit profile entity based on the ID data (1130).

The system provides, based on obtaining the credit profile data, an ID credit check confirmation associated with the ID data and phone number associated with the user (1140). For example, if the credit profile lookup succeeds, then the verification of user identification data is confirmed by the system.

In some implementations of the invention, the ID verification for the verified character string associated with the user is determined by receiving an ID verification request from a user device associated with the user via an application window of an ID verification user interface, receiving input of a first character string at an input field via the application window of the ID verification user interface, the first character string including the plurality of numbers associated with the phone number of the user device, providing a one-time passcode to the user device based on the first character string, receiving input of a second character string at an input field via the application window of the ID verification user interface, the second character string including one or more characters, and determining the verified character string based on matching the second character string to the one-time passcode.

In some implementations of the invention, determining the verification of ID data associated with the user is verified includes receiving a first selection that confirms the displayed portion of the ID data associated with the user is verified via an application window of an ID verification user interface.

In some implementations of the invention, determining the verification of ID data associated with the user is verified includes receiving a second selection that confirms the displayed portion of the ID data associated with the user is not verified via the application window of an ID verification user interface, displaying one or more additional user verification input fields via the application window of the ID verification user interface, receiving input of a third character string at the one or more additional user verification input fields via the application window of the ID verification user interface, the second character string including a plurality of characters or numbers associated with an address, and determining that the input of a third character string at the one or more additional user verification input fields confirms that the user is verified.

In some implementations of the invention, determining that the input of the third character string at the one or more additional user verification input fields confirms that the user is verified includes receiving a third selection that confirms a display of the input of the second character string at the one or more additional user verification input fields is verified via the application window of the ID verification user interface.

In some implementations of the invention, the process 1100 further includes the actions of determining, via a fraud detection module, whether the verification of the ID data associated with the user is fraudulent based on historical data and real-time data associated with the user. For example, in a phase I fraud detection (e.g., stage 530), the system will analyze the available inputs and the user's configuration for this phase, and the system declines to perform any further identity verification steps, and allows the process to continue.

In some implementations of the invention, the credit profile lookup is performed via a credit report application program interface (API) platform.

In some implementations of the invention, the process 1100 further includes the actions of determining, via a fraud detection module, whether the obtained ID data associated with the user is likely to be fraudulent based on historical data and real-time data associated with the user.

In some implementations of the invention, the process 1100 further includes the actions of determining a prequalification status for the user based on the obtained credit data. In some implementations of the invention, determining the prequalification status for the user includes a credit prequalification determination using a prequalification engine and based on at least one of a shop-by-payment service, a get prequalified service, or a single-product prequalification service. In some implementations of the invention, the prequalification engine is configured to ingest a plurality of user-based credit rates, a plurality of credit rules from a plurality of credit providers, and guidelines to determine credit qualifications for a plurality of users. In some implementations of the invention, the prequalification engine determines credit qualifications for the plurality of users using a machine learning algorithm that is trained to predict ratings using historical rate sheets from one or more of the plurality of credit providers.

In some implementations of the invention, the process 1100 further includes the actions of determining a net valuation for an item owned by the user based on the obtained identity and credit data. In some implementations of the invention, determining the valuation for an item owned by the user includes a trade-in equity valuation using a trade-in equity engine based on a credit-enhanced trade-in equity valuation service.

In some implementations of the invention, obtaining the ID data associated with a user of the user device from the data provider entity is based on a reverse phone lookup application program interface (API) service.

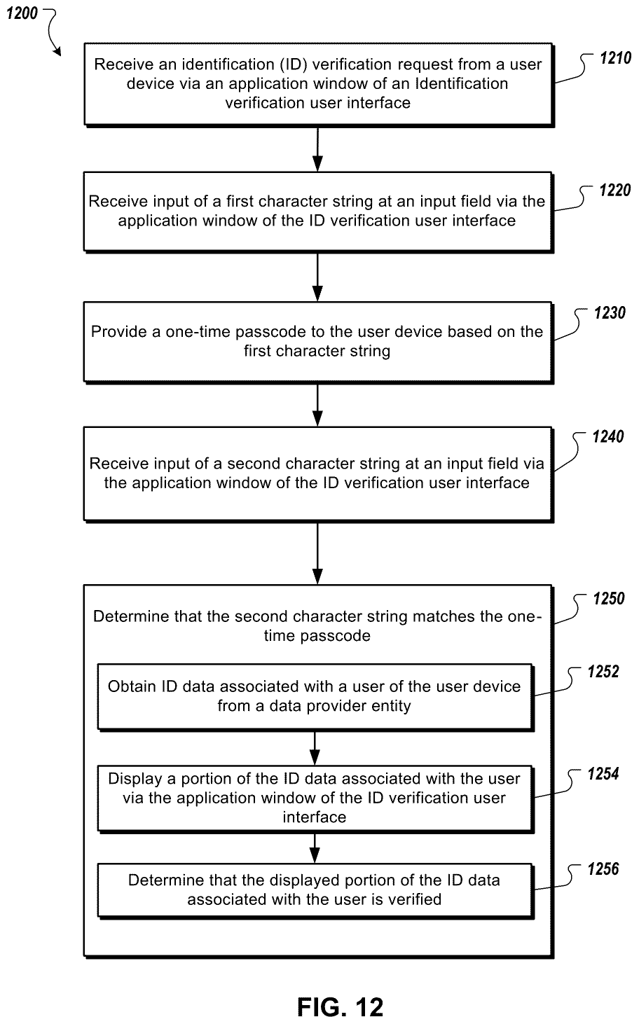

FIG. 12 illustrates a flowchart of an example process 1200 for implementing and providing an Identification authentication process, according to embodiments of the invention. Operations of the process 1200 can be implemented, for example, by a system that includes one or more data processing apparatus, such as one or more host platform server(s) 160 of FIG. 1 utilizing an Identification authentication instruction set 170 and utilizing one or more protocols (e.g., identification authentication protocol 220, marketplace notification protocol 250, and the like). The process 1200 can also be implemented by instructions stored on computer storage medium, where execution of the instructions by a system that includes a data processing apparatus cause the data processing apparatus to perform the operations of the process 1200.

The system, at a device that includes one or more processors, receives an identification (ID) verification request from a user device via an application window of an ID verification user interface (1210). For example, a host platform may provide access to a device (e.g., user device 110) via an ID verification user interface 402.

The system receives input of a first character string at an input field via the application window of the ID verification user interface (1220). For example, users can enter their phone number via the ID verification user interface 402, as illustrated in FIG. 4A.

The system provides a one-time passcode to the user device based on the first character string (1230).

The system receives input of a second character string at an input field via the application window of the ID verification user interface (1240). For example, as illustrated in the screenshot 400B of FIG. 4B, the identification authentication server 160 via the identification authentication instruction set 170 provides a random number to the user device via text, such as a random 6-digit number, and the user may enter that random number at element 410.

The system determines that the second character string matches the one-time passcode (1250), and in response obtains ID data associated with a user of the user device from a data provider entity (1252), displays a portion of the ID data associated with the user via the application window of the ID verification user interface (1254), and determines that the displayed portion of the ID data associated with the user is verified (1256). For example, as illustrated in the screenshot 400C of FIG. 4C, the identification authentication server 160 via the identification authentication instruction set 170 provides an identification associated with the reverse phone look up and requests confirmation from the user at element 422 that the name matches his or her name and/or address (e.g., “That's me!”, “That's not me”, etc.).

In some implementations of the invention, determining that the displayed portion of the ID data associated with the user is verified includes receiving a first selection that confirms the displayed portion of the ID data associated with the user is verified via the application window of the ID verification user interface. For example, a selection of “that's me” is received at element 420 of the ID verification user interface 402.

In some implementations of the invention, determining that the displayed portion of the ID data associated with the user is verified includes receiving a second selection that confirms the displayed portion of the ID data associated with the user is not verified via the application window of the ID verification user interface, displaying one or more additional user verification input fields via the application window of the ID verification user interface, receiving input of a third character string at the one or more additional user verification input fields via the application window of the ID verification user interface, the second character string including a plurality of characters or numbers associated with an address, and determining that the input of a third character string at the one or more additional user verification input fields confirms that the user is verified. For example, if the user selected “that's not me”, at element 420 of the ID verification user interface 402, then the process 1200 continues to screenshot 400D of FIG. 4D, an optional identity confirmation process (e.g., a subsequent confirmation step in a credit prequalification process because the user's name did not match as illustrated in FIG. 4C). In some implementations of the invention, determining that the input of the third character string at the one or more additional user verification input fields confirms that the user is verified includes receiving a third selection that confirms a display of the input of the second character string at the one or more additional user verification input fields is verified via the application window of the ID verification user interface. For example, as illustrated in example screenshot 400D, the ID verification user interface 402 at this stage allows the user to enter his or her additional personal data via the standard five-line data entry fields (e.g., UI area 430), so that the user can manually enter the data. Once the user enters the data, the system verifies the information, and if there is a match the process 500A proceeds to stage 530 to prepare to obtain the user's credit profile data (e.g., a credit profile lookup process).

In some implementations of the invention, the process 1200 may further include, in response to determining that the displayed portion of the ID data associated with the user is verified, obtaining credit profile data associated with the user from a data provider entity. For example, the host platform may receive credit profile data through an API from a credit profile reseller or directly from the credit profile. In some implementations of the invention, the credit profile data is obtained via a credit report API platform.

In some implementations of the invention, the process 1200 may further include determining a prequalification status for the user based on the credit profile data. In some implementations of the invention, determining the prequalification status for the user includes a credit prequalification determination using a prequalification engine and based on at least one of a shop-by-payment service, a get prequalified service, a single-product prequalification service, or a credit-enhanced equity valuation service. In some implementations of the invention, the prequalification engine is configured to ingest a plurality of user-based credit rates, a plurality of credit rules from a plurality of credit providers, and guidelines to determine credit qualifications for a plurality of users. In some implementations of the invention, the prequalification engine determines credit qualifications for the plurality of users using a machine learning algorithm that is trained to predict ratings using historical rate sheets from one or more of the plurality of credit providers.

In some implementations of the invention, obtaining the ID data associated with a user of the user device from the data provider entity is based on a reverse phone lookup application program interface (API) service.

### Example Use Case 1: Customer at an Automotive Dealership (get Prequalified Service)

### 1. Initial User Input

A customer at an automotive dealership sees all salespeople are busy, and scans a QR code on a showroom floor.
The customer's browser loads a webapp interface to the system, as configured for the dealership as the stakeholder.
The customer enters their phone number, and clicks a checkbox to consent to the prequalification process, including soft pull of credit.

### 2. Identity Verification

The system sends a One-Time Passcode to the phone number via SMS.
The customer receives the message, and enters the passcode into the application.
The system uses a third-party service successfully to look up the name and address associated with the phone number.
The application shows the name, and prompts the customer to confirm the name's correctness.
The customer confirms it is their name by clicking on the appropriate button.

### 3. Fraud Detection, Phase 1

The system assesses this is a “clean verification” so far.
The system uses a 3rd-party service to determine a likely current geographic location of the customer, based on their IP address. The result shows the same US state as the address associated with the phone number.
Based on the available inputs and the stakeholder's configuration for this phase, the system declines to perform any further identity verification steps, and allows the process to continue.

### 4. Credit Profile Lookup

The system successfully performs a credit profile lookup, using the name and address previously acquired.

### 5. Fraud Detection, Phase 2

The system assesses this is still a “clean verification”
No fraud detection inputs have changed, and the stakeholder's configuration for this phase does not require any additional identity verification actions.
The system again declines to perform any further identity verification steps, and allows the process to continue.

### 6. Prequalification

The system checks the stakeholder's statically-configured decisioning criteria, and determines the customer likely meets the criteria for several car loans.
The system generates additional details indicating an estimated maximum amount financeable of $53,000, and interest rates estimated to range from 9.49% to 12.49%, depending on the vehicle financed.

### 7. Communication of Results

The customer is shown a message indicating they are prequalified for loans of up $53,000 at rates as low as 9.49%
The stakeholder (the automotive dealer) is sent a message through their customer relationship management system, indicating that this customer:
   i. Has prequalified
   ii. With a “clean verification”
   iii. And no fraud warnings
   iv. For loans up to $53,000, with interest rates estimated to range from 9.49% to 12.49%

### 8. Summary of Benefit:

The customer:
   i. Received an estimate of the range of car loans they qualify for;
   ii. In less than a minute of interaction;
   iii. After providing only their phone number, consent to the process, a one-time passcode, and confirmation of their name;
   iv. Without having to wait for an available salesperson.
The automotive dealer:
   i. Received notification that the customer prequalifies for financing;
   ii. Based on identity information verified by trusted 3rd parties.

### Example Use Case 2: Fraudster Using a Lender's Website, with Failure at the Identity Verification Step

### 1. Initial User Input

A fraudster intends to buy a car with a loan under someone else's stolen identity, then resell the car privately without paying off the loan.
The fraudster goes to a lender's website, and clicks a button labeled “Get Prequalified”.
The application opens in an overlay over the lender's website, configured with the lender as the stakeholder.
The fraudster enters the phone number of their identity theft victim, and clicks a checkbox to consent to the prequalification process, including soft pull of credit.

### 2. Identity Verification

The system sends a One-Time Passcode to the phone number via SMS.
The identity theft victim receives the passcode message and, lacking any information about what to do with it, simply ignores it.
The application prompts the fraudster to enter the passcode, but since the fraudster doesn't have the passcode, the fraudster can't proceed, and closes the application.

### 3. Fraud Detection, Phase 1

N/A

### 4. Credit Profile Lookup

N/A

### 5. Fraud Detection, Phase 2

N/A

### 6. Prequalification

N/A

### 7. Communication of Results

N/A

### 8. Summary of Benefit:

The fraud was stopped before it even began.
Since the phone number was never verified, no information about this prequalification attempt is sent to the stakeholder, avoiding risk and potentially wasted resources contacting the fraudster.

### Example Use Case 3: Fraudster Using a Lender's Website, with Failure at the Fraud Detection (Phase 1) Step

### 1. Initial User Input

A fraudster intends to buy a car with a loan under someone else's stolen identity, then resell the car privately without paying off the loan. This time, the fraudster also has a prepaid phone they recently acquired to use in their attempt.
The fraudster goes to a lender's website, and clicks a button labeled “Get Prequalified”.
The application opens in an overlay over the lender's website, configured with the lender as the stakeholder.
The fraudster enters the phone number of their prepaid phone, and clicks a checkbox to consent to the prequalification process, including soft pull of credit.

### 2. Identity Verification

The system sends a One-Time Passcode to the phone number via SMS.
The fraudster receives the message, and enters the passcode into the application.
The system uses a third-party service to look up the name and address associated with the phone number, however the service does not return any information since this is a prepaid phone number.
The application shows a traditional form, and prompts the customer to enter their name and address.
The fraudster submits their victim's name and address.

### 3. Fraud Detection, Phase 1

The system assesses this is NOT a “clean verification” so far, as there was no name and address associated with the phone number.
Based on the stakeholder's configuration for this phase, the system now prompts the fraudster to upload scanned pictures of their driver's license.
The fraudster uploads photos of a real driver's license altered to match their victim's name and address.
The system uses a third-party service to validate the driver's license photos as belonging to the name and address entered via the form; the third-party service indicates the photos are invalid and possible fraud.
The system declines to continue the process, and prompts the fraudster to contact the stakeholder directly to continue working toward prequalification.
The system sends information about this attempt to the stakeholder's customer relationship management system, warning about the lack of “clean verification” and the failed driver's license validation.

### 4. Credit Profile Lookup

N/A

### 5. Fraud Detection, Phase 2

N/A

### 6. Prequalification

N/A

### 7. Communication of Results

N/A

### 8. Summary of Benefit:

The fraud was stopped without incurring the cost of a credit profile lookup on the stolen identity.
The stakeholder is now aware of a likely fraud attempt associated with the victim's name and address. The stakeholder can now flag this identity in their customer relationship management (CRM) system for extra review in case the fraudster tries again with the same stolen identity, helping prevent future fraud attempts even if attempted without using the system.

### Example Use Case 4: Customer Engages with an AI Persona on Behalf of an Automotive Dealer Running a Special Financing Program to Assist Credit-Challenged Car Shoppers, Via SMS (Get Prequalified Service, with Transition to Shop-by-Payment Service)

### 1. Initial User Input

A customer performs a web search for the phrase “car loan after bankruptcy”, and navigates to a webpage describing a special financing program for credit-challenged car shoppers, run by a local automotive dealer.
On the web search page, the customer sees a message of the form “Text us at <phone #> to start your car-buying process, even with bad credit!”
The customer engages in the following SMS conversation with the AI Persona that responds:
   Customer: “hi, can I really get a loan with bad credit”
   AI Persona: “Yes you can! Do you have a few minutes to get started now?”
   Customer: “yeah”
   AI Persona: “Do I have your permission to perform a soft credit check, to help you prequalify for a loan? It's OK if you have bad credit, and this won't have any impact on your credit score.”
   Customer: “sure”

### 2. Identity Verification

Since the AI Persona is already engaging with the customer via SMS, it is not necessary to further verify the phone number.
The system uses a third-party service successfully to look up the name and address associated with the phone number.
The conversation continues:
   AI Persona: “Will the loan be under the name ‘<fullname>’?”
   Customer: “yes”

### 3. Fraud Detection, Phase 1

The system assesses this is a “clean verification” so far.
Based on the available inputs and the stakeholder's configuration for this phase, the system declines to perform any further identity verification steps, and allows the process to continue.

### 4. Credit Profile Lookup

The system successfully performs a credit profile lookup, using the name and address previously acquired.

### 5. Fraud Detection, Phase 2

The system assesses this is still a “clean verification”
No fraud detection inputs have changed, however the stakeholder's configuration for this phase requires a check against a database of known stolen identities. The system uses a 3rd-party service provider to perform this check, which does not find any matches against known stolen identities.
The system declines to perform any other identity verification steps, and allows the process to continue.

### 6. Prequalification

The system checks the stakeholder's statically-configured decisioning criteria, and determines the customer likely meets the criteria for their financing program.
For this financing program, the system does not generate any additional details about likely financing prequalification.

### 7. Communication of Results

The conversation continues (without noticeable pause):
   AI Persona: “Great! You've prequalified!
The stakeholder (the automotive dealer) is sent a message through their customer relationship management system, indicating that this customer:
   Has prequalified
   With a “clean verification”
   No match against known stolen identities
   And no fraud warnings

### 8. Transition to Personalized Shop-by-Payment Experience

The conversation continues (without noticeable pause):
   AI Persona: “Now that we've gotten that out of the way, what kind of car are you thinking about buying? If you know what monthly payment would fit your budget, I can suggest some affordable options we have in stock today.”
   . . . the Customer and the AI Persona interact to quickly identify a vehicle the Customer would like to test drive, and set an appointment for the Customer to visit the dealership

### 9. Communication of Further Customer Engagement

The stakeholder (the automotive dealer) is sent a message through their customer relationship management system, updating the customer's record to indicate:
   The customer's vehicle preferences.
   The customer's monthly payment budget.
   The appointment for a test drive of the specifically-selected vehicle

### 10. Summary of Benefit:

The customer:
   Was informed that they can get a loan, even with their credit;
   With no noticeable waiting or pausing;
   After explicitly providing only their consent to the process and confirmation of their name via SMS;
   Was able to identify a vehicle that fits their preferences and budget, based on their personal prequalification for a financing program;
   Set an appointment to continue the car-buying process
   Through user-friendly and conversational interaction
The automotive dealer:
   Received notification that the customer prequalifies for financing;
   Based on identity information verified by trusted 3rd parties.
   Recorded details of the customer's preferences and budget;
   Set an appointment to continue the car-buying process.

### Example Use Case 5: Customer Using an Automotive Dealer's Website Wishing to Trade-In their Current Vehicle (Trade-In Equity Service, with Transition to Shop-by-Payment Service)

### 1. Initial User Input

A customer browsing inventory via an automotive dealership's website clicks a menu item offering to “Value You Trade-In”.
The customer's browser loads a webapp interface to the system, as configured for the dealership as the stakeholder.
The customer enters their phone number, and clicks a checkbox to consent to a soft pull credit profile lookup.

### 2. Identity Verification

The system sends a One-Time Passcode to the phone number via SMS.
The customer receives the message, and enters the passcode into the application.
The system uses a third-party service successfully to look up the name and address associated with the phone number.
The application shows the name, and prompts the customer to confirm the name's correctness.
The customer confirms it is their name by clicking on the appropriate button.

### 3. Fraud Detection, Phase 1

The system assesses this is a “clean verification” so far.
The system uses a 3rd-party service to determine a likely current geographic location of the customer, based on their IP address. The result shows the same US state as the address associated with the phone number.
Based on the available inputs and the stakeholder's configuration for this phase, the system declines to perform any further identity verification steps, and allows the process to continue.

### 4. Credit Profile Lookup

The system successfully performs a credit profile lookup, using the name and address previously acquired.

### 5. Fraud Detection, Phase 2

The system assesses this is still a “clean verification”
No fraud detection inputs have changed, and the stakeholder's configuration for this phase does not require any additional identity verification actions.
The system again declines to perform any further identity verification steps, and allows the process to continue.

### 6. Valuation

The system makes an API call to a 3rd-party data provider and retrieves public data for 2 vehicles registered to the customer's address.
The system displays some basic details about these 2 vehicles to the customer, and prompts the customer to indicate which of these is the vehicle they wish to value for trade-in, with a 3rd option for “neither of these vehicles”
The customer selects one of the 2 vehicle options presented.
The system prompts the customer to indicate the overall condition of the vehicle, presenting several condition options with descriptions that help the customer assess which best matches the condition of their vehicle.
The customer selects one of the condition options presented.
The system makes an API call to a 3rd-party data provider to retrieve an estimated trade-in value for the vehicle, based on the vehicle's registration data, the customer's zip code, and the indicated condition of the vehicle.
The system examines the customer's credit history and finds 2 likely automobile loans. Based on the lenders of the loans and the make of the vehicle as indicated by the registration data, the system is able to match the vehicle with its existing loan with high confidence.
The system displays the month and year of loan origination and the lender name for the matched loan to the customer, asking if the vehicle is financed through this loan.
The customer confirms that it is the correct loan.
The system generates trade-in valuation and equity details, indicating an estimated trade-in value of $16,900, a current loan principal of $3,150, a trade-in equity of $13,750 (calculated as the estimated trade-in value minus the current loan principal), and an available sales tax savings of up to $825 when combined with a car purchase based on local laws.

### 7. Communication of Results

The customer is shown a message indicating their trade-in would reduce the amount due for the purchase of a car by up to an estimated $14,575, assuming the accuracy of the car's condition.
The stakeholder (the automotive dealer) is sent a message through their customer relationship management system, indicating that this customer:
   i. Is interested in buying a car
   ii. With a “clean verification”
   iii. And no fraud warnings
   iv. With a trade-in vehicle valued at $16,900, with a loan payoff of $3,150, sales tax savings of up to $825

### 8. Transition to Personalized Shop-by-Payment Experience

The customer then clicks a button offering “See payments on in-stock vehicles, including your trade-in!”
Using the identification and credit data already obtained, the system prequalifies the customer against lending programs, and shows the user their prequalified payments for the dealer's in-stock inventory, incorporating the trade-in equity and sales tax savings in its payment calculations.

### 9. Summary of Benefit:

The customer:
   i. Received an estimate of the value of their trade-in, in terms of net reduction of amount due for a car purchase
   ii. In less than a minute of interaction;
   iii. After providing only their phone number, consent to the process, a one-time passcode, confirmation of their name, and selection of a displayed vehicle and a displayed loan;
   iv. Without having to travel to a dealership or talk with a salesperson;
   v. Without having to enter information about their vehicle, or look up the current principal on the loan.
   vi. Seamlessly transitioned to car shopping with no further input, seeing accurate payments for each vehicle, including their desired trade-in.
The automotive dealer:
   i. Received notification that the customer is interested in purchasing a car;
   ii. With identity information verified by trusted 3rd parties;
   iii. And with information about their intended trade-in to speed the sales process.

### Example Use Case 6: Customer at an Automotive Dealership (Single-Product Prequalification Service)

### 1. Initial User Input

A customer at an automotive dealership sees all salespeople are busy, and scans a QR code on the vehicle they're interested in purchasing.
The customer's browser loads a webapp interface to the system, as configured for the dealership as the stakeholder; the system records which vehicle's QR code was used.
The customer enters their phone number, and clicks a checkbox to consent to the prequalification process, including soft pull of credit.

### 2. Identity Verification

The system sends a One-Time Passcode to the phone number via SMS.
The customer receives the message, and enters the passcode into the application.
The system uses a third-party service successfully to look up the name and address associated with the phone number.
The application shows the name, and prompts the customer to confirm the name's correctness.
The customer confirms it is their name by clicking on the appropriate button.

### 3. Fraud Detection, Phase 1

The system assesses this is a “clean verification” so far.
The system uses a 3rd-party service to determine a likely current geographic location of the customer, based on their IP address. The result shows the same US state as the address associated with the phone number.
Based on the available inputs and the stakeholder's configuration for this phase, the system declines to perform any further identity verification steps, and allows the process to continue.

### 4. Credit Profile Lookup

The system successfully performs a credit profile lookup, using the name and address previously acquired.

### 5. Fraud Detection, Phase 2

The system assesses this is still a “clean verification”
No fraud detection inputs have changed, and the stakeholder's configuration for this phase does not require any additional identity verification actions.
The system again declines to perform any further identity verification steps, and allows the process to continue.

### 6. Prequalification

The system checks the stakeholder's statically-configured decisioning criteria, and determines the customer likely meets the criteria for several car loans and leases.
The system calculates the monthly payments available for the specific car (recorded when the app first loaded, based on the specific QR code used), across all of the prequalified financing programs and a range of available financing terms.

### 7. Interactive Communication of Results.

The customer is shown a grid of prequalified payments for the car, where each displayed payment is the lowest payment available (across the prequalified financing programs) for each available term, for each of loan and lease financing types.
The customer is given the option to enter a downpayment amount, provide trade-in information, etc., as the customer provides additional information, they are shown updated prequalified payments in real time (less than a second delay for each modification).
The customer selects a customized payment from the grid, and is given the option to place a hold on the vehicle and begin digital paperwork for the purchase (transition to digital retailing)
The stakeholder (the automotive dealer) is sent a message through their customer relationship management system, indicating that this customer:
   i. Has prequalified
   ii. With a “clean verification”
   iii. And no fraud warnings
   iv. Has initiated digital retailing for a specific vehicle

### 8. Summary of Benefit:

The customer:
   i. Received a range of prequalified payment options;
   ii. For a specific vehicle they are interested in purchasing;
   iii. In less than a minute of interaction;
   iv. After providing only their phone number, consent to the process, a one-time passcode, and confirmation of their name;
   v. Then customized their financing and transaction details;
   vi. And initiated the purchase process;
   vii. Without having to wait for an available salesperson.
The automotive dealer:
   i. Received notification that the customer prequalifies for financing;
   ii. Based on identity information verified by trusted 3rd parties.

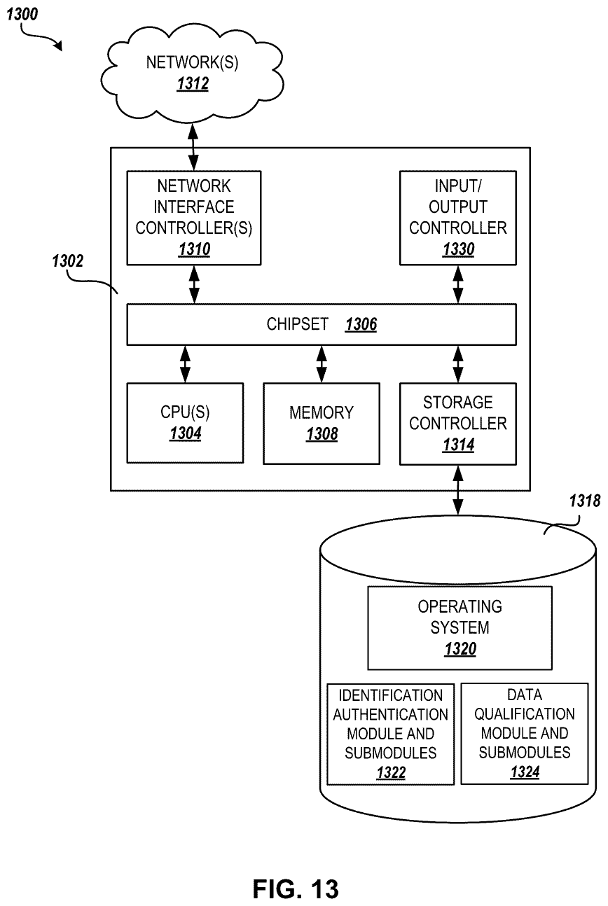

FIG. 13 illustrates an example computer architecture 1300 for a computer 1302 capable of executing the software components described herein for the sending/receiving and processing of tasks. The computer architecture 1300 (also referred to herein as a “server”) shown in FIG. 13 illustrates a server computer, workstation, desktop computer, laptop, a server operating in a cloud environment, or other computing device, and may be utilized to execute any aspects of the software components presented herein described as executing on a host server, or other computing platform. The computer 1302 preferably includes a baseboard, or “motherboard,” which is a printed circuit board to which a multitude of components or devices may be connected by way of a system bus or other electrical communication paths. In one illustrative embodiment, one or more central processing units (CPUs) 1304 operate in conjunction with a chipset 1306. The CPUs 1304 can be programmable processors that perform arithmetic and logical operations necessary for the operation of the computer 1302.

The CPUs 1304 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The chipset 1306 provides an interface between the CPUs 1304 and the remainder of the components and devices on the baseboard. The chipset 1306 may provide an interface to a memory 1308. The memory 1308 may include a random-access memory (RAM) used as the main memory in the computer 1302. The memory 1308 may further include a computer-readable storage medium such as a read-only memory (ROM) or non-volatile RAM (NVRAM) for storing basic routines that help to startup the computer 1302 and to transfer information between the various components and devices. The ROM or NVRAM may also store other software components necessary for the operation of the computer 1302 in accordance with the embodiments described herein.

According to various embodiments, the computer 1302 may operate in a networked environment using logical connections to remote computing devices through one or more networks 1312, a local-area network (LAN), a wide-area network (WAN), the Internet, or any other networking topology known in the art that connects the computer 1302 to the devices and other remote computers. The chipset 1306 includes functionality for providing network connectivity through one or more network interface controllers (NICs) 1310, such as a gigabit Ethernet adapter. For example, the NIC 1310 may be capable of connecting the computer 1302 to other computer devices in the utility provider's systems. It should be appreciated that any number of NICs 1310 may be present in the computer 1302, connecting the computer to other types of networks and remote computer systems beyond those described herein.

The computer 1302 may be connected to at least one mass storage device 1318 that provides non-volatile storage for the computer 1302. The mass storage device 1318 may store system programs, application programs, other program modules, and data, which are described in greater detail herein. The mass storage device 1318 may be connected to the computer 1302 through a storage controller 1314 connected to the chipset 1306. The mass storage device 1318 may consist of one or more physical storage units. The storage controller 1314 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 1302 may store data on the mass storage device 1318 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 1318 is characterized as primary or secondary storage, or the like. For example, the computer 1302 may store information to the mass storage device 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1302 may further read information from the mass storage device 1318 by detecting the physical states or characteristics of one or more particular locations within the physical storage units.

The mass storage device 1318 may store an operating system 1320 utilized to control the operation of the computer 1302. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 1318 may store other system or application programs and data utilized by the computer 1302, such as the identification authentication module and submodules 1322, which may include the Identification authentication instruction set 170 and the one or more submodules included therein, according to embodiments described herein. For example, the Identification authentication module and submodules 1322 may include submodules such as the API/portal module 172, the identification module 174, the fraud detection module 175, the integration module 176, the database module 178, and/or other modules discussed herein or may otherwise be appropriate. The mass storage device 1318 may further store other system or application programs and data utilized by the computer 1302, such as the data qualification module and submodules 1324, which may include the data qualification instruction set 180 and the one or more submodules included therein, according to embodiments described herein. For example, the data qualification module and submodules 1324 may include submodules such as the API/portal module 182, the valuation module 183, the prequalification module 184, the dynamic quote module 186, the rate prediction module 188, and/or other modules discussed herein or may otherwise be appropriate. Other system or application programs and data utilized by the computer 1302 may be provided as well (e.g., a security module, a fraud module, a validation module, etc.).

In some embodiments, the mass storage device 1318 may be encoded with computer-executable instructions that, when loaded into the computer 1302, transforms the computer 1302 from being a general-purpose computing system into a special-purpose computer capable of implementing the embodiments described herein. These computer-executable instructions transform the computer 1302 by specifying how the CPUs 1304 transition between states, as described above. According to some embodiments, from the host platform server(s) 160 perspective, the mass storage device 1318 stores computer-executable instructions that, when executed by the computer 1302, perform portions of the process 1100 and/or 1200, for implementing an identification authentication system, and/or perform portions of the process 1500, for implementing an onboarding integration system, as described herein. In further embodiments, the computer 1302 may have access to other computer-readable storage medium in addition to or as an alternative to the mass storage device 1318.

The computer 1302 may also include an input/output controller 1330 for receiving and processing input from a number of input devices, such as a keyboard, a mouse, a touchpad, a touch screen, an electronic stylus, or other type of input device. Similarly, the input/output controller 1330 may provide output to a display device, such as a computer monitor, a flat-panel display, a digital projector, a printer, a plotter, or other type of output device. It will be appreciated that the computer 1302 may not include all of the components shown in FIG. 13, may include other components that are not explicitly shown in FIG. 13, or may utilize an architecture completely different than that shown in FIG. 13.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A computer-implemented method comprising:
at an electronic device having a processor:
receiving confirmation of an identification (ID) verification for an already-verified character string associated with a user, the verified character string comprising a plurality of numbers associated with a phone number of a user device;
determining, based on the phone number, a verification of ID data associated with the user by obtaining the ID data from a data provider entity;
obtaining credit profile data associated with the user from a credit profile entity based on the ID data; and
providing, based on obtaining the credit profile data, an ID credit check confirmation associated with the ID data and phone number associated with the user.

2. The method of claim 1, wherein the ID verification for the verified character string associated with the user is determined by:
receiving an ID verification request from a user device associated with the user via an application window of an ID verification user interface;
receiving input of a first character string at an input field via the application window of the ID verification user interface, the first character string comprising the plurality of numbers associated with the phone number of the user device;
providing a one-time passcode to the user device based on the first character string;
receiving input of a second character string at an input field via the application window of the ID verification user interface, the second character string comprising one or more characters; and
determining the verified character string based on matching the second character string to the one-time passcode.

3. The method of claim 1, wherein determining the verification of ID data associated with the user is verified comprises receiving a first selection that confirms the displayed portion of the ID data associated with the user is verified via an application window of an ID verification user interface.

4. The method of claim 1, wherein determining the verification of ID data associated with the user is verified comprises:
receiving a second selection that confirms the displayed portion of the ID data associated with the user is not verified via the application window of an ID verification user interface;
displaying one or more additional user verification input fields via the application window of the ID verification user interface;
receiving input of a third character string at the one or more additional user verification input fields via the application window of the ID verification user interface, the second character string comprising a plurality of characters or numbers associated with an address; and
determining that the input of a third character string at the one or more additional user verification input fields confirms that the user is verified.

5. The method of claim 4, wherein determining that the input of the third character string at the one or more additional user verification input fields confirms that the user is verified comprises receiving a third selection that confirms a display of the input of the second character string at the one or more additional user verification input fields is verified via the application window of the ID verification user interface.

6. The method of claim 1, further comprising:
determining, via a fraud detection module, whether the verification of the ID data associated with the user is likely to be fraudulent based on historical data and real-time data associated with the user.

7. The method of claim 1, wherein the credit profile data is obtained via a credit report application program interface (API) platform.

8. The method of claim 1, further comprising:
determining, via a fraud detection module, whether the obtained credit data associated with the user from the credit profile entity is likely to be fraudulent based on historical data and real-time data associated with the user.

9. The method of claim 1, further comprising:
determining a prequalification status for the user based on the obtained credit profile data.

10. The method of claim 9, wherein determining the prequalification status for the user comprises a credit prequalification determination using a prequalification engine and based on at least one a shop-by-payment service, a get prequalified service, or a single-product prequalification service.

11. The method of claim 10, wherein the prequalification engine is configured to ingest a plurality of user-based credit rates, a plurality of credit rules from a plurality of credit providers, and guidelines to determine credit qualifications for a plurality of users.

12. The method of claim 11, wherein the prequalification engine determines credit qualifications for the plurality of users using a machine learning algorithm that is trained to predict ratings using historical rate sheets from one or more of the plurality of credit providers.

13. The method of claim 11, wherein the prequalification engine determines credit qualifications for the plurality of users using a machine learning algorithm that is trained to predict rates using historical data of rates granted to other users by one or more of the plurality of credit providers along with historical credit profile data for those users.

14. The method of claim 1, further comprising:
determining the net valuation for an item owned by the user based on the obtained credit profile data.

15. The method of claim 14, wherein determining the net valuation for an item owned by the user comprises a credit-enhanced valuation using a trade-in equity engine and based on a credit-enhanced trade-in equity valuation service.

16. The method of claim 1, wherein obtaining the ID data associated with a user from the data provider entity is based on a reverse phone lookup application program interface (API) service.

17. A device comprising:
a non-transitory computer-readable storage medium; and
one or more processors coupled to the non-transitory computer-readable storage medium, wherein the non-transitory computer-readable storage medium comprises program instructions that, when executed by the one or more processors, cause the one or more processors to perform operations comprising:
receiving confirmation of an identification (ID) verification for an already-verified character string associated with a user, the verified character string comprising a plurality of numbers associated with a phone number of a user device;
determining, based on the phone number, a verification of ID data associated with the user by obtaining the ID data from a data provider entity;
obtaining credit profile data associated with the user from a credit profile entity based on the ID data; and
providing, based on obtaining the credit profile data, an ID credit check confirmation associated with the ID data and phone number associated with the user.

18. The device of claim 17, wherein the ID verification for the verified character string associated with the user is determined by:
receiving an ID verification request from a user device associated with the user via an application window of an ID verification user interface;
receiving input of a first character string at an input field via the application window of the ID verification user interface, the first character string comprising the plurality of numbers associated with the phone number of the user device;
providing a one-time passcode to the user device based on the first character string;
receiving input of a second character string at an input field via the application window of the ID verification user interface, the second character string comprising one or more characters; and
determining the verified character string based on matching the second character string to the one-time passcode.

19. The device of claim 17, wherein determining the verification of ID data associated with the user is verified comprises receiving a first selection that confirms the displayed portion of the ID data associated with the user is verified via an application window of an ID verification user interface.

20. A non-transitory computer storage medium encoded with a computer program, the computer program comprising a plurality of program instructions that when executed by one or more processors cause the one or more processors to:
receiving confirmation of an identification (ID) verification for an already-verified character string associated with a user, the verified character string comprising a plurality of numbers associated with a phone number of a user device;
determining, based on the phone number, a verification of ID data associated with the user by obtaining the ID data from a data provider entity;
obtaining credit profile data associated with the user from a credit profile entity based on the ID data; and
providing, based on obtaining the credit profile data, an ID credit check confirmation associated with the ID data and phone number associated with the user.
